(19) United States
(12) Patent Application Publication
(10) Pub. No.: US 2013/0145945 A1
(43) Pub. Date: Jun. 13, 2013

(54) RESIN COMPOSITION FOR LASER ENGRAVING, FLEXOGRAPHIC PRINTING PLATE PRECURSOR FOR LASER ENGRAVING AND PROCESS FOR PRODUCING SAME, AND FLEXOGRAPHIC PRINTING PLATE AND PROCESS FOR MAKING SAME

(71) Applicant: FUJIFILM CORPORATION, Tokyo (JP)

(72) Inventors: Shigefumi KANCHIKU, Haibara-gun (JP); Yuusuke KOZAWA, Haibara-gun (JP)

(73) Assignee: FUJIFILM CORPORATION, Tokyo (JP)

(21) Appl. No.: 13/707,197

(22) Filed: Dec. 6, 2012

(30) Foreign Application Priority Data
Dec. 9, 2011 (JP) 2011-270499

(51) Int. Cl. B41N 1/00; B05D 3/06; B05D 3/02

(52) U.S. Cl. CPC B41N 1/00; B05D 3/0254; B05D 3/06
USPC 101/395; 526/194; 525/454; 525/451; 525/328.8; 427/387; 427/385.5; 427/554

(57) ABSTRACT

Disclosed is a resin composition for laser engraving, comprising (Component A) an oligomer or polymer having a (meth)acryloyloxy group in the molecule, (Component B) an ethylenically unsaturated compound, (Component C) a compound having in the molecule at least one type selected from the group consisting of a mercapto group, a primary amino group, and a secondary amino group and at least one type of hydrolyzable silyl group and/or silanol group, and (Component D) a thermopolymerization initiator.

### TECHNICAL FIELD

The present invention relates to a resin composition for laser engraving, a flexographic printing plate precursor for laser engraving and a process for producing the same, and a flexographic printing plate and a process for making the same.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb the laser light and convert it into heat.

As a resin composition for laser engraving, those described in International publication WO 2005/084959 or JP-A-2011-136455 (JP-A denotes a Japanese unexamined patent application publication) are known.

### SUMMARY OF INVENTION

It is an object of the present invention to provide a resin composition for laser engraving that can give a flexographic printing plate having a high insolubilization ratio with respect to solvent and excellent surface tackiness, sensitivity, engraving residue rinsing properties, ink transfer properties, and printing durability, a flexographic printing plate precursor and a process for producing same employing the resin composition for laser engraving, and a flexographic printing plate and a process for making same.

The above-mentioned object of the present invention has been attained by solution means <1>, <7> to <11>, and <15> beloshey are described below together with <2> to <6> and <12> to <14>, which are preferred embodiments.

<1> A resin composition for laser engraving, comprising (Component A) an oligomer or polymer having a (meth)acryloyloxy group in the molecule, (Component B) an ethylenically unsaturated compound, (Component C) a compound having in the molecule at least one type selected from the group consisting of a mercapto group, a primary amino group, and a secondary amino group and at least one type of hydrolyzable silyl group and/or silanol group, and (Component D) a thermopolymerization initiator,
<2> the resin composition for laser engraving according to <1>, wherein Component A has a urethane bond in the molecule,
<3> the resin composition for laser engraving according to <1> or <2>, wherein Component A is a straight-chain oligomer or polymer and has a (meth)acryloyloxy group at both termini,
<4> the resin composition for laser engraving according to any one of <1> to <3>, wherein it further comprises (Component E) a photothermal conversion agent,
<5> the resin composition for laser engraving according to any one of <1> to <4>, wherein it further comprises (Component F) an alcohol exchange reaction catalyst,
<6> the resin composition for laser engraving according to any one of <1> to <5>, wherein it further comprises (Component G) a silane coupling agent,
<7> a flexographic printing plate precursor for laser engraving, comprising above a support a relief-forming layer comprising the resin composition for laser engraving according to any one of <1> to <6>,
<8> a flexographic printing plate precursor for laser engraving, comprising above a support a crosslinked relief-forming layer formed by crosslinking by means of heat a relief-forming layer comprising the resin composition for laser engraving according to any one of <1> to <6>,
<9> a process for producing a flexographic printing plate precursor for laser engraving, the process comprising a layer formation step of forming a relief-forming layer comprising the resin composition for laser engraving according to any one of <1> to <6>, and a crosslinking step of crosslinking the relief-forming layer by means of heat to thus obtain a flexographic printing plate precursor comprising a crosslinked relief-forming layer,
<10> a process for making a flexographic printing plate comprising, in this order, a step of preparing a flexographic printing plate precursor for laser engraving comprising a crosslinked relief-forming layer formed by crosslinking by means of heat a relief-forming layer comprising the resin composition for laser engraving according to any one of <1> to <6>, and an engraving step of laser-engraving the crosslinked relief-forming layer so as to form a relief layer,
<11> a flexographic printing plate produced by the process according to <10>,
<12> the flexographic printing plate according to <11>, wherein the relief layer has a thickness of at least 0.05 mm but no greater than 10 mm,
<13> the flexographic printing plate precursor according to <8>, wherein the crosslinked relief-forming layer has a Shore A hardness of at least 50° but no greater than 90°,
<14> the flexographic printing plate according to <11> or <12>, wherein the relief layer has a Shore A hardness of at least 50° but no greater than 90°, and
<15> use of the resin composition for laser engraving according to any one of <1> to <6> for a relief-forming layer of a flexographic printing plate precursor for laser engraving.

### DESCRIPTION OF EMBODIMENTS

The present invention is explained in detail below.

In the present invention, the notation ‘lower limit to upper limit’, which expresses a numerical range, means ‘at least the lower limit but no greater than the upper limit’, and the notation ‘upper limit to lower limit’ means ‘no greater than the upper limit but at least the lower limit’. That is, they are numerical ranges that include the upper limit and the lower limit. Furthermore, ‘(Component A) an oligomer or polymer having a (meth)acryloyloxy group in the molecule’ etc. are simply called ‘Component A’ etc.

In the present invention, ‘mass %’ is used for the same meaning as ‘weight %’, and ‘parts by mass’ is used for the same meaning as ‘parts by weight’.

In the present invention, ‘(meth)acrylate’ means ‘acrylate’ and/or ‘methacylate’.

### (Resin Composition for Laser Engraving)

The resin composition for laser engraving of the present invention (hereinafter, also simply called a ‘resin composition’) comprises (Component A) an oligomer or polymer having a (meth)acryloyloxy group in the molecule, (Component B) an ethylenically unsaturated compound, (Component C) a compound having in the molecule at least one type selected from the group consisting of a mercapto group, a primary amino group, and a secondary amino group and at least one type of hydrolyzable silyl group and/or silanol group, and (Component D) a thermopolymerization initiator.

Due to Component A to Component D being contained, the resin composition for laser engraving of the present invention can provide a flexographic printing plate that has a high insolubilization ratio with respect to solvent and excellent surface tackiness, sensitivity, engraving residue rinsing properties, ink transfer properties, and printing durability.

In the present invention, ‘a flexographic printing plate having excellent surface tackiness’ means a flexographic printing plate having a suppressed surface tackiness.

The resin composition for laser engraving of the present invention may be applied to a wide range of uses where it is subjected to laser engraving, other than use as a relief-forming layer of a flexographic printing plate precursor, without particular limitations. For example, it may be applied not only to a relief-forming layer of a printing plate precursor where formation of a raised relief is carried out by laser engraving, which is explained in detail below, but also to the formation of various types of printing plates or various types of moldings in which image formation is carried out by laser engraving, such as another material form having asperities or openings formed on the surface such as for example an intaglio printing plate, a stencil printing plate, or a stamp.

Among them, the application thereof to the formation of a relief-forming layer provided on an appropriate support is a preferred embodiment.

In the present specification, with respect to explanation of the flexographic printing plate precursor, a non-crosslinked crosslinkable layer comprising Component A to Component D and having a flat surface as an image formation layer that is subjected to laser engraving is called a relief-forming layer, a layer that is formed by crosslinking the relief-forming layer is called a crosslinked relief-forming layer, and a layer that is formed by subjecting this to laser engraving so as to form asperities on the surface is called a relief layer.

Constituent components of the resin composition for laser engraving are explained below.

### (Component A) Oligomer or Polymer Having (Meth)Acryloyloxy Group in the Molecule

The resin composition for laser engraving of the present invention comprises (Component A) an oligomer or polymer having a (meth)acryloyloxy group in the molecule. In the present invention, an oligomer means a polymer having a weight-average molecular weight of at least 2,000 but less than 10,000, and a polymer means a polymer having a weight-average molecular weight of at least 10,000 but no greater than 1,000,000.

Component A is an oligomer or polymer having a (meth)acryloyloxy group in the molecule. Component A may have a (meth)acryloyloxy group at any position in the molecule of Component A but preferably has one at both molecular termini, and when Component A is a straight-chain oligomer or polymer it more preferably has one at both termini of a main chain. It is surmised that due to both termini of a main chain having a (meth)acryloyloxy group rather than a side chain having a (meth)acryloyloxy group, the flexibility of a crosslinked relief-forming layer and a relief layer (hereinafter, a crosslinked relief-forming layer and a relief layer are also collectively called a relief film) further improves, and ink transfer properties become better. In the present invention, the ‘main chain’ means the longest bonded chain, among chains, of a polymer compound molecule constituting an oligomer or a polymer, and the ‘side chain’ means a carbon chain branching from the main chain.

The number of (meth)acryloyloxy groups of Component A is preferably 1 to 10 per molecule, more preferably 2 to 6, yet more preferably 2 to 4, and particularly preferably 2.

Component A being a straight chain means it being a polymer not intentionally having a branched structure, a crosslinked structure, or a net structure introduced thereinto and comprising substantially none of these structures.

Furthermore, identification of a structure with regard to whether or not Component A is a straight chain, etc. may be carried out by combining various analytical methods such as NMR, pyrolysis GS-MS, GPC, HPLC, and dynamic and static light scattering methods.

Component A preferably has a urethane bond in the molecule. In accordance with the use of a urethane bond-containing Component A, the film strength of a relief film that is obtained increases outstandingly and the printing durability improves. Preferred examples include a urethane (meth)acrylate oligomer or polymer in which a (meth)acryloyloxy group has been introduced into a urethane oligomer or a polyurethane resin (hereinafter, also called a urethane acrylate, etc.). Furthermore, it is preferable for Component A to be a straight-chain oligomer or polymer and to have a (meth)acryloyloxy group at both termini, that is, both termini of the main chain.

The weight-average molecular weight of Component A is preferably 2,000 to 500,000, more preferably 3,000 to 500,000, yet more preferably 10,000 to 300,000, and particularly preferably 15,000 to 150,000.

When the weight-average molecular weight of Component A is in this range, a relief film obtained from the resin composition of the present invention has high strength, the printing durability of a printing plate improves, the thermal decomposition properties of a relief-forming layer at the time of laser engraving are good, and the engraving sensitivity is excellent.

The weight-average molecular weight of Component A can be determined by using GPC, and by using a calibration curve of polystyrene.

Component A is preferably a plastomer at 20° C. The term ‘plastomer’ as used in the present invention means, as described in ‘Shinpan Kobunshi Jiten (Newly-published Polymer Encyclopedia)’ edited by the Society of Polymer Science, Japan (published in 1988 by Asakura Publishing Co., Ltd., Japan), a macromolecule which has a property of easily undergoing fluid deformation by heating and being capable of solidifying into a deformed shape by cooling. The term ‘plastomer’ is a term opposed to the term ‘elastomer’ (a polymer having a property of, when an external force is added, instantaneously deforming in accordance with the external force, and when the external force is removed, being restored to the original shape in a short time), and the plastomer does not exhibit the same elastic deformation as that exhibited by an elastomer, and easily undergoes plastic deformation.

In the present invention, a plastomer means a polymer which, when the original size is designated as 100%, can be deformed up to 200% of the original size by a small external force at room temperature (20° C.), and even if the external force is removed, does not return to 130% or less of the original size. More particularly, the plastomer means a polymer with which, based on the tensile permanent strain test of JIS K 6262-1997, an I-shaped specimen can be extended to 2 times the gauge length before pulling in a tensile test at 20° C., and the tensile permanent strain measured after extending the specimen to 2 times the gauge length before pulling, subsequently maintaining the specimen for 5 minutes, removing the external tensile force, and maintaining the specimen for 5 minutes, is 30% or greater.

Meanwhile, in the case of a polymer that cannot be subjected to the measurement described above, a polymer which is deformed even if an external force is not applied and does not return to the original shape, corresponds to a plastomer, and for example, a syrup-like resin, an oil-like resin, and a liquid resin correspond thereto.

Furthermore, the plastomer according to the present invention is such that the glass transition temperature (Tg) of the polymer is lower than 20° C. In the case of a polymer having two or more Tg's, all the Tg's are lower than 20° C.

The viscosity of Component A at 20° C. is preferably 10 Pa·s to 10 kPa·s, and more preferably 50 Pa·s to 5 kPa·s. When the viscosity is in this range, the resin composition can be easily molded into a sheet-like or cylindrical printing plate precursor, and the process is also simple and easy. In the present invention, since Component A is a plastomer, when the printing plate precursor for laser engraving obtainable from the resin composition is molded into a sheet form or a cylindrical form, a satisfactory thickness accuracy or a satisfactory dimensional accuracy can be achieved.

A method for introducing a (meth)acryloyloxy group into Component A may be carried out in accordance with a known method for introducing a functional group into an oligomer or a polymer. For example, there can be cited a method in which a starting material having a (meth)acryloyloxy group is used as a polymerizable compound that is a starting material for forming an oligomer or a polymer. Alternatively, there can be cited a method in which an oligomer or polymer having a reactive group at a main chain terminal or in a side chain undergoes a polymer reaction with a compound having a (meth)acryloyloxy group and a functional group that reacts with the reactive group.

Examples of the former include a method in which a urethane acrylate is formed by a polyaddition reaction between a diisocyanate compound and a diol compound having a (meth)acryloyloxy group.

Examples of the latter include a method in which an oligomer or polymer having a (meth)acryloyloxy group in the molecule is formed by reacting a reactive group such as a hydroxy group or an amino group in the main chain or a side chain of an acrylate resin, polyester, polyurethane, polycarbonate, etc. with (meth)acrylic acid, a (meth)acrylic acid halide, etc.

In the present invention, preferred examples of Component A include a polycarbonate oligomer or polycarbonate resin having a (meth)acryloyloxy group, an acrylic oligomer or acrylic resin having a (meth)acryloyloxy group, a polyester oligomer or polyester resin having a (meth)acryloyloxy group, and a urethane oligomer or polyurethane resin having a (meth)acryloyloxy group.

In the present invention, as preferred examples of an oligomer or polymer that is a starting material for a Component A into which a (meth)acryloyloxy group is introduced, there can be cited (Compound a-i) a polycarbonate polyol, (Compound a-ii) an acrylic resin, (Compound a-iii) a polyester resin having a hydroxy group at a molecular terminal, and (Compound a-iv) a polyurethane resin having a hydroxy group at a molecular terminal.

By reacting a reactive group such as a hydroxy group or an amino group of the oligomers or polymers of Compound a-i to Compound a-iv above with (meth)acrylic acid or a (meth)acrylic acid halide there may be obtained, as Component A, (i) an oligomer or polymer having a polycarbonate polyol as the main chain and having a (meth)acryloyloxy group in the molecule (hereinafter, also called a polycarbonate (meth)acrylate, etc.), (ii) an oligomer or polymer having an acrylic resin as the main chain and having a (meth)acryloyloxy group in the molecule (hereinafter, also called an acrylic resin (meth)acrylate, etc.), (iii) an oligomer or polymer having a polyester as the main chain and having a (meth)acryloyloxy group in the molecule (hereinafter, also called a polyester (meth)acrylate, etc.), and (iv) an oligomer or polymer having a polyurethane as the main chain and having a (meth)acryloyloxy group in the molecule (hereinafter, also called a urethane (meth)acrylate, etc.).

Compound a-i to Compound a-iv are each explained in detail below.

(Compound a-i) Polycarbonate Polyol

In the present invention, (Compound a-i) a polycarbonate polyol may be used as the main chain of Component A, and among them a polycarbonate diol is preferable.

Examples of the polycarbonate polyol include those obtained by a reaction between a polyol component and a carbonate compound such as a dialkyl carbonate, an alkylene carbonate, or a diaryl carbonate.

Examples of the polyol component forming the polycarbonate polyol include those usually used in the production of a polycarbonate polyol, for example, an aliphatic diol having 2 to 15 carbons such as ethylene glycol, diethylene glycol, triethylene glycol, propylene glycol, 1,3-propanediol, 2-methyl-1,3-propanediol, 2,2-diethyl-1,3-propanediol, 1,3-butanediol, 1,4-butanediol, 2-methyl-1,4-butanediol, neopentyl glycol, 1,5-pentanediol, 3-methyl-1,5-pentanediol, 1,6-hexanediol, 1,7-heptanediol, 1,8-octanediol, 2-methyl-1,8-octanediol, 2,7-dimethyl-1,8-octanediol, 1,9-nonanediol, 2-methyl-1,9-nonanediol, 2,8-dimethyl-1,9-nonanediol, or 1,10-decanediol; an alicyclic diol such as 1,4-cyclohexanediol, cyclohexanedimethanol, or cyclooctanedimethanol; an aromatic diol such as 1,4-bis(β-hydroxyethoxy)benzene; and a polyhydric alcohol having three or more hydroxy groups per molecule such as trimethylolpropane, trimethylolethane, glycerol, 1,2,6-hexanetriol, pentaerythritol, or diglycerol. When producing a polycarbonate polyol, with regard to these polyol components, one type thereof may be used or two or more types thereof may be used in combination.

Among them, when producing the polycarbonate polyol, it is preferable to use as the polyol component an aliphatic diol having 5 to 12 carbons and having a methyl group as a side chain, such as 2-methyl-1,4-butanediol, 3-methyl-1,5-pentanediol, 2-methyl-1,8-octanediol, 2,7-dimethyl-1,8-octanediol, 2-methyl-1,9-nonanediol, or 2,8-dimethyl-1,9-nonanediol. In particular, it is preferable to use such an aliphatic diol having 5 to 12 carbons and having a methyl group as a side chain at a proportion of at least 30 mole % of the total polyol components used in the production of the polyester polyol, and more preferably at least 50 mole % of the total polyol components.

Examples of the dialkyl carbonate include dimethyl carbonate and diethyl carbonate, examples of the alkylene carbonate include ethylene carbonate, and examples of the diaryl carbonate include diphenyl carbonate.

As the polycarbonate polyol, a polyester polycarbonate polyol can be used, and examples thereof include a polymer obtainable by allowing a polyol component, a polycarboxylic acid component and a carbonate compound to simultaneously react; a polymer obtainable by allowing a polyester polyol and a polycarbonate polyol that have been synthesized in advance to react with a carbonate compound; and a polymer obtainable by allowing a polyester polyol and a polycarbonate polyol that have been synthesized in advance to react with a polyol component and a polycarboxylic acid component.

The polycarbonate polyol is preferably a polycarbonate diol represented by Formula (1) below.

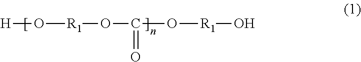

In Formula (1), the R₁s independently denote a straight-chain, branched, and/or cyclic hydrocarbon group having 3 to 50 carbons, which may contain an oxygen atom, etc. (at least one type of atom selected from the group consisting of nitrogen, sulfur, and oxygen) in a carbon skeleton, and R₁ may be a single component or comprise a plurality of components. n is preferably an integer of 1 to 500.

The ‘hydrocarbon group’ in R₁ is a saturated or unsaturated hydrocarbon group, but is preferably a saturated hydrocarbon group.

The ‘carbon skeleton’ in R₁ means a structural part having 3 to 50 carbons forming the hydrocarbon group, and the term ‘which may contain an oxygen atom, etc. in a carbon skeleton’ means a structure in which an oxygen atom, etc. is inserted into a carbon-carbon bond of a main chain or a side chain. Furthermore, it may be a substituent having an oxygen atom, etc., bonded to a carbon atom in a main chain or a side chain.

Examples of the straight-chain hydrocarbon group in R₁ include a hydrocarbon group derived from a straight-chain aliphatic diol having 3 to 50 carbons such as 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,16-hexadecanediol, or 1,20-eicosanediol.

Examples of the branched hydrocarbon group in R₁ include a hydrocarbon group derived from a branched aliphatic diol having 3 to 30 carbons such as 2-methyl-1,3-propanediol, 2-ethyl-1,3-propanediol, neopentyl glycol, 2,2-diethyl-1,3-propanediol, 2-methyl-2-propyl-1,3-propanediol, 2-butyl-2-ethyl-1,3-propanediol, 2,2-dibutyl-1,3-propanediol, 1,2-butanediol, 2-ethyl-1,4-butanediol, 2-isopropyl-1,4-butanediol, 2,3-dimethyl-1,4-butanediol, 2,3-diethyl-1,4-butanediol, 3,3-dimethyl-1,2-butanediol, pinacol, 1,2-pentanediol, 1,3-pentanediol, 2,3-pentanediol, 2-methyl-2,4-pentanediol, 3-methyl-1,5-pentanediol, 2-ethyl-1,5-pentanediol, 3-ethyl-1,5-pentanediol, 2-isopropyl-1,5-pentanediol, 3-isopropyl-1,5-pentanediol, 2,4-dimethyl-1,5-pentanediol, 2,4-diethyl-1,5-pentanediol, 2,3-dimethyl-1,5-pentanediol, 2,2,3-trimethyl-1,3-pentanediol, 1,2-hexanediol, 1,3-hexanediol, 1,4-hexanediol, 2,5-hexanediol, 2-ethyl-1,6-hexanediol, 2-ethyl-1,3-hexanediol, 2-isopropyl-1,6-hexanediol, 2,4-diethyl-1,6-hexanediol, 2,5-dimethyl-2,5-hexanediol, 2-methyl-1,8-octanediol, 2-ethyl-1,8-octanediol, 2,6-dimethyl-1,8-octanediol, 1,2-decanediol, or 8,13-dimethyl-1,20-eicosanediol.

Examples of the cyclic hydrocarbon group in R₁ include a hydrocarbon group derived from a cyclic aliphatic diol or an aromatic diol having 3 to 30 carbons such as 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, m-xylene-α,α′-diol, p-xylene-α,α′-diol, 2,2-bis(4-hydroxycyclohexyl)propane, 2,2-bis(4-hydroxyphenyl)propane, or dimer diol.

A hydrocarbon group derived from a straight-chain aliphatic diol having 3 to 50 carbons is explained as an example: in the present invention, the ‘hydrocarbon group derived from a straight-chain aliphatic diol having 3 to 50 carbons’ means a group which is a partial structure, excluding the diol hydroxy groups, of the straight-chain aliphatic diol having 3 to 50 carbons.

Examples of the hydrocarbon group containing at least one type of atom selected from the group consisting of nitrogen, sulfur, and oxygen in R₁ include a hydrocarbon group derived from diethylene glycol, triethylene glycol, tetraethylene glycol, glycerol, 1,2,6-hexanetriol, trimethylolethane, trimethylolpropane, pentaerythritol, dihydroxyacetone, 1,4:3,6-dianhydroglucitol, diethanolamine, N-methyldiethanolamine, dihydroxyethylacetamide, 2,2′-dithiodiethanol, or 2,5-dihydroxy-1,4-dithiane, and a croup represented by Formula (2) below.

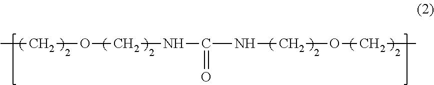

A polycarbonate diol may be produced by for example a conventionally known method as described in JP-B-5-29648 (JP-B denotes a Japanese examined patent application publication), and specifically it may be produced by an ester exchange reaction between a diol and a carbonic acid ester.

In Formula (1) above, from the viewpoint of solvent resistance, R₁ preferably contains at least one ether bond, and from the viewpoint of solvent resistance and durability, R₁ more preferably contains a group derived from diethylene glycol (group represented by —(CH₂)₂—O—(CH₂)₂—), and R₁ is yet more preferably a group derived from diethylene glycol.

The weight-average molecular weight of these polycarbonate polyols is preferably in the range of 3,000 to 500,000, more preferably in the range of 10,000 to 300,000, and yet more preferably in the range of 15,000 to 150,000.

(Compound a-ii) Acrylic Resin

In the present invention, (Compound a-ii) an acrylic resin may be used as the main chain of Component A.

The acrylic resin is not particularly limited as long as it is an acrylic resin that is obtained by the use of a known (meth)acrylic monomer, but it preferably has —OH, —SH, —NH—, —NH₂, —COOH, etc. in the molecule as a reactive group.

Among them, —OH, —NH—, or —NH₂ is preferable, and —OH (a hydroxy group) is particularly preferable.

Examples of the (meth)acrylic monomers used for synthesizing an acrylic resin having a hydroxy group include preferably (meth)acrylic acid esters, crotonic acid esters and (meth)acrylamides having a hydroxy group in the molecule. Specific examples of such monomers include 2-hydroxyethyl (meth)acrylate, 2-hydroxypropyl (meth)acrylate, 4-hydroxybutyl (meth)acrylate etc.

The acrylic resin having a hydroxy group at a terminal may comprise a homopolymer and a copolymer of an acrylic monomer having a hydroxy group, and is preferably a copolymer of an acrylic monomer having a hydroxy group and an acrylic monomer other than the acrylic monomer having a hydroxy group.

Examples of the acrylic monomer other than the acrylic monomer having a hydroxy group, which is copolymerizable with the acrylic monomer having a hydroxy group, include a (meth)acrylic ester, and specific examples of the (meth)acrylic ester include methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, 2-ethylhexyl (meth)acrylate, lauryl (meth)acrylate, acetoxyethyl (meth)acrylate, phenyl (meth)acrylate, 2-methoxyethyl (meth)acrylate, 2-ethoxyethyl (meth)acrylate, 2-(2-methoxyethoxy)ethyl (meth)acrylate, cyclohexyl (meth)acrylate, t-butylcyclohexyl (meth)acrylate, benzyl (meth)acrylate, diethylene glycol monomethyl ether (meth)acrylate, diethylene glycol monoethyl ether (meth)acrylate, diethylene glycol monophenyl ether (meth)acrylate, triethylene glycol monomethyl ether (meth)acrylate, triethylene glycol monoethyl ether (meth)acrylate, dipropylene glycol monomethyl ether (meth)acrylate, polyethylene glycol monomethyl ether (meth)acrylate, polypropylene glycol monomethyl ether (meth)acrylate, the monomethyl ether (meth)acrylate of a copolymer of ethylene glycol and propylene glycol, N,N-dimethylaminoethyl (meth)acrylate, N,N-diethylaminoethyl (meth)acrylate, and N,N-dimethylaminopropyl (meth)acrylate.

In the present invention, the acrylic resin may be a homopolymer of a hydroxy group-containing (meth)acrylic monomer or a copolymer of a plurality of different monomers. In the case of a copolymer, the ratio of constituent units may be selected freely. Furthermore, as the acrylic resin, a modified acrylic resin formed from a urethane group- or urea group-containing acrylic monomer may also be preferably used.

Among them, from the viewpoint of ink transfer properties, an alkyl (meth)acrylate such as lauryl (meth)acrylate or 2-ethylhexyl (meth)acrylate, a (meth)acrylate having an ether bond in the main chain such as polyethylene glycol monomethyl ether (meth)acrylate or polypropylene glycol monomethyl ether (meth)acrylate, and a (meth)acrylate having an aliphatic cyclic structure such as t-butylcyclohexyl (meth)acrylate are particularly preferable.

(Compound a-iii) Polyester Resin Having Hydroxy Group at Molecular Terminal

In the present invention, (Compound a-iii) a polyester resin having a hydroxy group at a molecular terminal may be used as the main chain of Component A. Compound a-iii is preferably a polyester resin having a hydroxy group at a main chain terminal, and more preferably one having a hydroxy group at both main chain termini.

It is preferable for Compound a-iii to be a resin formed by an esterification reaction or an ester exchange reaction from at least one type of polybasic acid component and at least one type of polyhydric alcohol component.

Specific examples of the polybasic acid component include dibasic acids such as phthalic acid, isophthalic acid, terephthalic acid, tetrahydrophthalic acid, hexahydrophthalic acid, succinic acid, fumaric acid, adipic acid, sebacic acid, and maleic acid; trivlaent or higher-valent polybasic acids such as trimellitic acid, methylcyclohexene tricarboxylic acid, and pyromellitic acid; and acid anhydrides thereof, for example, phthalic anhydride, tetrahydrophthalic anhydride, hexahydrophthalic anhydride, maleic anhydride, trimellitic anhydride, and pyromellitic anhydride.

As the polybasic acid component, one or more dibasic acids selected from the dibasic acids described above, lower alkyl ester compounds of these acids, and acid anhydrides are mainly used. Furthermore, if necessary, a monobasic acid such as benzoic acid, crotonic acid or p-t-butylbenzoic acid; a trivalent or higher-valent polybasic acid such as trimellitic anhydride, methylcyclohexene tricarboxylic acid or pyromellitic anhydride; or the like can be further used in combination.

The polybasic acid component according to the present invention preferably includes at least adipic acid, from the viewpoint of ink transfer properties.

Specific examples of the polyhydric alcohol component include divalent alcohols such as ethylene glycol, diethylene glycol, propylene glycol, dipropylene glycol, 1,4-butanediol, neopentyl glycol, 1,5-pentanediol, 3-methylpentanediol, 1,4-hexanediol, and 1,6-hexanediol; and trivalent or higher-valent polyhydric alcohols such as glycerol, trimethylolethane, trimethylolpropane, and pentaerythritol.

As the polyhydric alcohol component, the divalent alcohols described above are mainly used, and if necessary, trivalent or higher-valent polyhydric alcohols such as glycerol, trimethylolethane, trimethylolpropane, and pentaerythritol can be further used in combination. These polyhydric alcohols can be used individually, or as mixtures of two or more kinds.

The polyhydric alcohol component according to the present invention preferably includes at least 3-methylpentanediol, from the viewpoint of storage stability.

The esterification reaction or ester exchange reaction of the polybasic acid component and the polyhydric alcohol component can be carried out by using a usually used method without particular limitations.

Examples of commercially available polyester (meth)acrylates include EBECRYL 524, EBECRYL 884, and EBECRYL 885 (all manufactured by Daicel-Cytec Company Ltd.).

(Compound a-iv) Polyurethane Resin Having Hydroxy Group at Molecular Terminal

In the present invention, as the main chain of Component A, (Compound a-iv) a polyurethane resin having a hydroxy group at a molecular terminal may be used. Compound a-iv is preferably a polyurethane resin having a hydroxy group at a main chain terminal, and more preferably one having a hydroxy group at both main chain termini.

Compound a-iv is formed by reacting at least one type of polyisocyanate and at least one type of polyhydric alcohol component.

Compound a-iv preferably includes a polycarbonate diol formed from a repeating unit represented by Formula (4):

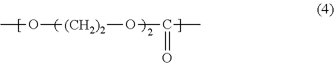

The repeating unit of Formula (4) may contain a linear and/or branched molecular chain. The polycarbonate diol can be produced from a corresponding diol by a known method (for example, JP-B-5-29648).

Compound a-iv preferably further has at least one bond selected from a carbonate bond and an ester bond in the molecule. When Compound a-iv has the bonds described above, the resistance of a printing plate to an ink cleaning agent containing an ester-based solvent or an ink cleaning agent containing a hydrocarbon-based solvent, which are used in printing, tends to improve, which is preferable.

The method for producing Compound a-iv is not particularly limited, and for example, a method of allowing a compound having a carbonate bond or an ester bond, and having plural reactive groups such as a hydroxy group, an amino group, an epoxy group, a carboxy group, an acid anhydride group, a ketone group, a hydrazine residue, an isocyanate group, an isothiocyanate group, a cyclic carbonate group, or an alkoxycarbonyl group, with a molecular weight of about several thousands, to react with a compound having plural functional groups that are capable of bonding with the reactive groups (for example, a polyisocyanate having a hydroxy group, an amino group or the like), and performing regulation of the molecular weight and conversion of the molecular terminal to bondable groups, and the like can be used.

Examples of the diol compound having a carbonate bond, which is used in the production of Compound a-iv, include aliphatic polycarbonate diols such as 4,6-polyalkylene carbonate diol, 8,9-polyalkylene carbonate diol, and 5,6-polyalkylene carbonate diol. Furthermore, an aliphatic polycarbonate diol having an aromatic molecular structure in the molecule may also be used. When the hydroxy groups at the terminal of these compounds are subjected to a condensation reaction with a diisocyanate compound such as tolylene diisocyanate, diphenylmethane diisocyanate, hexamethylene diisocyanate, isophorone diisocyanate, dicyclohexylmethane diisocyanate, tetramethylxylene diisocyanate, xylene diisocyanate, naphthalene diisocyanate, trimethylhexamethylene diisocyanate, p-phenylene diisocyanate, cyclohexylene diisocyanate, lysine diisocyanate, or triphenylmethane diisocyanate; or a triisocyanate compound such as triphenylmethane triisocyanate, 1-methylbenzene-2,4,6-triisocyanate, naphthalene-1,3,7-triisocyanate, or biphenyl-2,4,4′-triisocyanate, a urethane bond can be introduced to the compounds.

Examples of commercially available urethane (meth)acrylates, etc. include UV-3200, UV-3000B, UV-3700B, UV-3210EA, and UV-2000B of the Shikoh (registered trademark) series (all manufactured by The Nippon Synthetic Chemical Industry Co., Ltd.), EBECRYL 230 and EBECRYL 9227EA (both manufactured by Daicel-Cytec Company Ltd.), and AU-3040, AU-3050, AU-3090, AU-3110, and AU-3120 of the Hi-Coap AU (registered trademark) series (all manufactured by Tokushiki Co., Ltd.).

As another method for obtaining a urethane (meth)acrylate, etc., there is a method in which a polyurethane is formed by a polyaddition reaction between the polyisocyanate compound and a diol compound having a (meth)acryloyloxy group.

Preferred examples of the diol compound having a (meth)acryloyloxy group used in this case include Blemmer GLM (glycerol monomethacrylate) manufactured by NOF Corporation and DA-212, DA-250, DA-721, DA-722, DA-911M, DA-920, DA-931, DM-201, DM-811, DM-832, and DM-851 of the ‘Denacol Acrylate (registered trademark)’ series manufactured by Nagase ChemteX Corporation.

Among them, Component A is preferably a urethane oligomer or polyurethane resin (urethane (meth)acrylate) having a (meth)acryloyloxy group as described above, more preferably a urethane oligomer or polyurethane resin having a (meth)acryloyloxy group at a main chain terminal, and particularly preferably a straight chain urethane oligomer or polyurethane having a (meth)acryloyloxy group at a main chain terminal.

Furthermore, from the viewpoint of solvent resistance, one having a polybutadiene structure, a hydrogenated polybutadiene structure, or a polyisoprene structure in the main chain is particularly preferable.

In the resin composition of the present invention, Component A can be used singly or in combination of two or more types.

The content of Component A in the resin composition is preferably 5 mass % to 90 mass %, more preferably 15 mass % to 85 mass %, and even more preferably 30 mass % to 80 mass %, relative to the total mass of the solids content. If the content of Component A is in the range described above, a relief layer having excellent rinsing properties of engraving residue and excellent ink transfer properties is obtained, which is preferable.

The resin composition for laser engraving of the present invention may comprise a binder polymer (resin component) other than Component A. The examples of the binder polymer other than Component A include the non-elastomers described in JP-A-2011-136455, and the unsaturated group-containing polymers described in JP-A-2010-208326.

The resin composition for laser engraving of the present invention preferably comprises Component A as a main component of the binder polymers, and if the resin composition comprises other binder polymers, the content of Component A relative to the total mass of the binder polymers is preferably 60 mass % or greater, more preferably 70 mass % or greater, and even more preferably 80 mass % or greater. Meanwhile, the upper limit of the content of Component A is not particularly limited, and is particularly preferable 100 mass %. However, if the resin composition comprises other binder polymers, the upper limit thereof is preferably 99 mass % or less, more preferably 97 mass % or less, and even more preferably 95 mass % or less.

### (Component B) Ethylenically Unsaturated Compound

The resin composition of the present invention comprises (Component B) an ethylenically unsaturated compound. The ethylenically unsaturated compound is a compound having at least one ethylenically unsaturated bond that can be radically polymerized by means of an initiating radical derived from and generated by a polymerization initiator. Due to the ethylenically unsaturated compound being contained, it is possible to impart to a relief-forming layer the property of curing by crosslinking.

The ethylenically unsaturated compound may be freely selected from compounds having at least one, preferably at least two, and more preferably two to six ethylenically unsaturated bonds. The ethylenically unsaturated compound is a compound having a molecular weight (weight-average molecular weight when there is a molecular weight distribution) of less than 2,000. Furthermore, Component B does not include a compound having a hydrolyzable silyl group and/or a silanol group. The ethylenically unsaturated compound is not particularly limited; a known compound may be used, and examples include polymerizable compounds (hereinafter, also called monomers) described in JP-A-2009-255510 and paragraphs 0098 to 0124 of JP-A-2009-204962.

Since it is necessary to form a crosslinked structure in the relief-forming layer in the present invention, a polyfunctional monomer having at least two ethylenically unsaturated bond is preferably used as Component B. The molecular weight of these polyfunctional monomers is preferably at least 120 and less than 2,000, and more preferably at least 200 and less than 2,000.

Examples of the monofunctional monomer and polyfunctional monomer include an ester of an unsaturated carboxylic acid (e.g. acrylic acid, methacrylic acid, itaconic acid, crotonic acid, isocrotonic acid, maleic acid, etc.) and a polyhydric alcohol compound and an amide of an unsaturated carboxylic acid and a polyamine compound.

Specific examples of a monomer that is an ester of an aliphatic polyhydric alcohol compound or an aromatic polyhydric alcohol compound and an unsaturated carboxylic acid include a (meth)acrylic acid ester such as ethylene glycol di(meth)acrylate, triethylene glycol di(meth)acrylate, 1,3-butanediol di(meth)acrylate, tetramethylene glycol di(meth)acrylate, propylene glycol di(meth)acrylate, neopentyl glycol di(meth)acrylate, trimethylolpropane tri(meth)acrylate, trimethylolpropane tri((meth)acryloyloxypropyl)ether, trimethylolethane tri(meth)acrylate, hexanediol di(meth)acrylate, 1,4-cyclohexanediol di(meth)acrylate, tetraethylene glycol di(meth)acrylate, pentaerythritol di(meth)acrylate, pentaerythritol tri(meth)acrylate, pentaerythritol tetra(meth)acrylate, dipentaerythritol di(meth)acrylate, dipentaerythritol hexa(meth)acrylate, sorbitol tri(meth)acrylate, sorbitol tetra(meth)acrylate, sorbitol penta(meth)acrylate, sorbitol hexa(meth)acrylate, tri((meth)acryloyloxyethyl)isocyanurate, bis[p-(3-(meth)acryloxy-2-hydroxypropoxy)phenyl]dimethylmethane, bis[p-((meth)acryloxyethoxy)phenyl]dimethylmethane, hydrogenated bisphenol A di(meth)acrylate, hydrogenated bisphenol F di(meth)acrylate, a di(meth)acrylate of an ethylene oxide adduct of bisphenol A, a di(meth)acrylate of a propylene oxide adduct of bisphenol A, a di(meth)acrylate of an ethylene oxide adduct of bisphenol F, a di(meth)acrylate of a propylene oxide adduct of bisphenol F, a di(meth)acrylate of an ethylene oxide adduct of hydrogenated bisphenol A, and a di(meth)acrylate of a propylene oxide adduct of hydrogenated bisphenol A, and among them a di- to hexa-functional (meth)acrylate derivative of pentaerythritol or dipentaerythritol and a bisphenol type di(meth)acrylate are preferable, and dipentaerythritol hexa(meth)acrylate and bisphenol A-based di(meth)acrylate are more preferable. As the bisphenol A-based di(meth)acrylate, one having added thereto one to six ethylene oxide groups per molecule is yet more preferable. The ester monomer may be used as a mixture.

In the present invention, Component B may be used singly or in a combination of two or more types.

From the viewpoint of flexibility and brittleness of the crosslinked film, the content of Component B in the resin composition of the present invention is preferably 0.01 to 80 mass % relative to the total mass on a solid component basis, more preferably 1 to 60 mass %, and yet more preferably 3 to 30 mass %.

(Component C) Compound Having in Molecule at Least One Type Selected from Group Consisting of Mercapto Group, Primary Amino Group, and Secondary Amino Group and at Least One Type of Hydrolyzable Silyl Group and/or Silanol Group

The resin composition of the present invention comprises (Component C) a compound having in the molecule at least one type selected from the group consisting of a mercapto group, a primary amino group, and a secondary amino group and at least one type of hydrolyzable silyl group and/or silanol group.

It is surmised that due to the resin composition of the present invention comprising Component C, surface tackiness caused by inhibition of polymerization by oxygen on the surface of a relief-forming layer obtained from the resin composition is improved. It is thought that, whereas radical polymerization of component A or Component B is inhibited by oxygen, Component C can form an adduct with a (meth)acryloyloxy group of Component A or Component B by Michael addition or a chain transfer reaction without being much affected by oxygen. It is surmised that monomer remaining on the surface due to insufficient polymerization (insufficient curing) as a result of the effect of oxygen can be post-cured by a reaction with Component C, thus improving the surface tackiness.

Furthermore, it is surmised that due to having at least one type of hydrolyzable silyl group and/or silanol group, an effect in improving the rinsing properties at the time of laser engraving is also obtained.

The number of said at least one type of group selected from the group consisting of a mercapto group, a primary amino group, and a secondary amino group in Component C is preferably one to six per one molecule of Component C, more preferably one to three, and particularly preferably one. It is surmised that when in this range the crosslinked structure of a relief-forming layer does not become too dense, the flexibility is good, and the ink transfer properties improve.

Furthermore, the number of said at least one type of group of hydrolyzable silyl group and/or silanol group in Component C is preferably one to three per one molecule of Component C, more preferably one or two, and particularly preferably one. When in this range, the rinsing properties of a flexographic printing plate are good.

From the viewpoint of odor of the resin composition Component C preferably has a primary amino group or a secondary amino group rather than a mercapto group, but from the viewpoint of film strength (printing durability) a mercapto group is preferred to a primary amino group or a secondary amino group. It is surmised that a mercapto group functions more effectively as a chain transfer agent in crosslinking of a relief-forming layer.

Component C is preferably a compound represented by Formula (C-0) below.

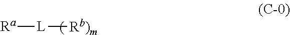

(In the Formula, R^{a} denotes a hydrolyzable silyl group and/or a silanol group, R^{b} denotes at least one type of group selected from the group consisting of a mercapto group, a primary amino group, and a secondary amino group, L denotes an (m+1)-valent organic linking group, and m denotes an integer of 1 to 6.)

With regard to the group denoted by R^{a} in Formula (C-0), the ‘hydrolyzable silyl group’ is a silyl group having hydrolyzability. Examples of the hydrolyzable group include an alkoxy group, a mercapto group, a halogen atom, an amide group, an acetoxy group, an amino group, and an isopropenoxy group. A silyl group undergoes hydrolysis to become a silanol group, and a silanol group undergoes dehydration-condensation to form a siloxane bond. Such a hydrolyzable silyl group and/or silanol group is preferably one represented by Formula (C-1).

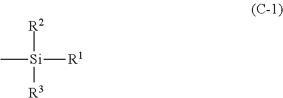

In Formula (C-1) above, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group. The remainder of R¹ to R³ independently denotes a hydrogen atom, or a monovalent organic substituent (examples including an alkyl group, an aryl group, an alkenyl group, an alkynyl group, and an aralkyl group).

In Formula (C-1) above, the hydrolyzable group bonded to the silicon atom is particularly preferably an alkoxy group or a halogen atom, and more preferably an alkoxy group. From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms, and most preferably a methoxy group or an ethoxy group. Furthermore, examples of the halogen atom include an F atom, a Cl atom, a Br atom, and an I atom, and from the viewpoint of ease of synthesis and stability it is preferably a Cl atom or a Br atom, and more preferably a Cl atom.

Component C has at least one group represented by Formula (C-1), that is Component C has at least one hydrolyzable silyl group and/or silanol group.

A range of 1 to 3 of the hydrolyzable group may bond to one silicon atom, and preferable the total number of hydrolyzable groups in Formula (C-1) is preferably in a range of 2 or 3. It is particularly preferable that three hydrolyzable groups bond to a silicon atom. When two or more hydrolyzable groups are bonded to a silicon atom, they may be identical to or different from each other.

Specific preferred examples of the alkoxy group include a methoxy group, an ethoxy group, a propoxy group, an isopropoxy group, a butoxy group, a tert-butoxy group, a phenoxy group, and a benzyloxy group. A plurality of each of these alkoxy groups may be used in combination, or a plurality of different alkoxy groups may be used in combination.

Examples of the alkoxysilyl group having an alkoxy group bonded thereto include a trialkoxysilyl group such as a trimethoxysilyl group, a triethoxysilyl group, a triisopropoxysilyl group, or a triphenoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group.

In Formula (C-0), R^{b} denotes at least one type of group selected from the group consisting of a mercapto group, a primary amino group, and a secondary amino group.

The secondary amino group is not particularly limited, and various types may be used. As a substituent on the secondary amino group other than a hydrogen atom, an aliphatic hydrocarbon group having 1 to 20 carbons and an aromatic hydrocarbon group having 6 to 30 carbons are preferable. The aliphatic hydrocarbon group may have a straight-chain, branched, or alicyclic structure, and may comprise a heteroatom such as an oxygen atom, a nitrogen atom, or a sulfur atom in a carbon chain. It may have a substituent such as an amino group, a mercapto group, or a halogen atom. The aromatic hydrocarbon group may be monocyclic or may be a polycyclic structure, including a condensed ring, or may be a heterocyclic group containing the heteroatom. The aromatic ring may have a substituent, and the substituent is preferably an alkyl group having 1 to 6 carbons, an alkoxy group, a halogen atom, an amino group, or a mercapto group. When Component C has a plurality of secondary amino groups, they may be identical to or different from each other.

In Formula (C-0), L denotes a di- to hepta-valent, preferably di- to tetra-valent, and particularly preferably divalent, organic linking group. L is preferably an aliphatic hydrocarbon group having 1 to 20 carbons or an aromatic hydrocarbon group having 6 to 30 carbons. The aliphatic hydrocarbon group may have a straight-chain, branched, or alicyclic structure, and may comprise a heteroatom such as an oxygen atom, a nitrogen atom, or a sulfur atom in a carbon chain.

m denotes an integer of 1 to 6, preferably 1 to 3, and particularly preferably 1.

Specific preferred examples of Component C include 3-mercaptopropyldimethylmethoxysilane, 3-mercaptopropylmethyldimethoxysilane, 3-mercaptopropyltrimethoxysilane, 3-mercaptopropyldiethylmethoxysilane, 3-mercaptopropylethyldimethoxysilane, 3-mercaptopropyldiethylethoxysilane, 3-mercaptopropylethyldiethoxysilane, 3-mercaptopropyltriethoxysilane, 3-aminopropyltrimethoxysilane, 3-aminopropyltriethoxysilane, N-2-(aminoethyl)-3-aminopropylmethyldimethoxysilane, N-2-(aminoethyl)-3-aminopropyltrimethoxysilane, N-2-(aminoethyl)-3-aminopropylmethyldiethoxysilane, N-2-(aminoethyl)-3-aminopropyltriethoxysilane, N-2-(aminoethyl)-3-aminopropylethyldimethoxysilane, N-2-(aminoethyl)-3-aminopropylethyldiethoxysilane, N-phenyl-3-aminopropyltriethoxysilane, and N-phenyl-3-aminopropyltrimethoxysilane. Among them, 3-mercaptopropylmethyldimethoxysilane, 3-mercaptopropyltrimethoxysilane, 3-aminopropyltrimethoxysilane, 3-aminopropyltriethoxysilane, N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, and N-phenyl-3-aminopropyltrimethoxysilane are more preferable.

The resin composition for laser engraving of the present invention may comprise one type of Component C or two or more types thereof in combination.

The content of Component C is preferably 0.5 to 30 mass % relative to the total solids content of the resin composition, more preferably 1 to 20 mass %, and yet more preferably 2 to 10 mass %.

### (Component D) Thermopolymerization Initiator

The resin composition for laser engraving of the present invention comprises (Component D) a thermopolymerization initiator.

Any thermopolymerization initiator known to a person skilled in the art may be used without any restrictions. A radical thermopolymerization initiator, which is a preferred thermopolymerization initiator, is explained in detail below, but the present invention is not restricted by these descriptions.

In the present invention, from the viewpoint of engraving sensitivity and, when applied to a relief-forming layer of a flexographic printing plate precursor, a better relief edge shape, the thermopolymerization initiator is preferably an organic peroxide or an azo-based compound, and particularly preferably an organic peroxide. As the organic peroxide and the azo-based compound, the compounds shown below are preferable.

### <Organic Peroxide>

Preferred examples of the organic peroxide as a thermopolymerization initiator that can be used in the present invention include peroxyester-based ones such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-t-butyldiperoxyisophthalate, and t-butylperoxybenzoate, and dicumylperoxide.

### <Azo Compounds>

Preferable azo compounds as a thermopolymerization initiator that can be used in the present invention include those such as 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

In the present invention, the organic peroxide is particularly preferable as the thermopolymerization initiator in the present invention from the viewpoint of crosslinking properties of the film (relief-forming layer) and improving the engraving sensitivity.

From the viewpoint of the engraving sensitivity, an embodiment obtained by combining an organic peroxide, Component A and Component E described below is particularly preferable.

This is presumed as follows. When the relief-forming layer is cured by thermal crosslinking using an organic peroxide, an organic peroxide that did not play a part in radical generation and has not reacted remains, and the remaining organic peroxide works as an autoreactive additive and decomposes exothermally in laser engraving. As the result, energy of generated heat is added to the irradiated laser energy to thus raise the engraving sensitivity.

It will be described in detail in the explanation of (Component E) the photothermal converting agent, the effect thereof is remarkable when carbon black is used as the photothermal converting agent. It is considered that the heat generated from the carbon black is also transmitted to an organic peroxide and, as the result, heat is generated not only from the carbon black but also from the organic peroxide, and that the generation of heat energy to be used for the decomposition of Component A etc. occurs synergistically.

Component D in the resin composition of the present invention may be used singly or in a combination of two or more compounds.

The content of Component D in the resin composition of the present invention is preferably 0.1 to 5 mass % relative to the total mass of the solids content, more preferably 0.3 to 3 mass %, and particularly preferably 0.5 to 1.5 mass %.

### (Component E) Photothermal Conversion Agent

The resin composition for laser engraving of the present invention preferably further includes a photothermal conversion agent. That is, it is considered that the photothermal conversion agent in the present invention can promote the thermal decomposition of a cured material during laser engraving by absorbing laser light and generating heat. Therefore, it is preferable that a photothermal conversion agent capable of absorbing light having a wavelength of laser used for engraving be selected.

When a laser (a YAG laser, a semiconductor laser, a fiber laser, a surface emitting laser, etc.) emitting infrared at a wavelength of 700 to 1,300 nm is used as a light source for laser engraving, it is preferable for the flexographic printing plate precursor for laser engraving which is produced by using the resin composition for laser engraving of the present invention to comprise a photothermal conversion agent that has a maximum absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, and preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saishin Ganryo Ouyogijutsu’ (Latest Applications of Pigment Technology) (CMC Publishing, 1986), ‘Insatsu Inki Gijutsu’ (Printing Ink Technology) (CMC Publishing, 1984). Examples of pigments include pigments described in paragraphs 0122 to 0125 of JP-A-2009-178869.

Among these pigments, carbon black is especially preferable.

Any carbon black, regardless of classification by ASTM (American Society for Testing and Materials) and application (e.g. for coloring, for rubber, for dry cell, etc.), may be used as long as dispersibility, etc. in the resin composition for laser engraving is stable. Examples of the carbon black include furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products. Examples of carbon black include carbon blacks described in paragraphs 0130 to 0134 of JP-A-2009-178869.

Component E in the resin composition of the present invention may be used singly or in a combination of two or more compounds.

The content of the photothermal conversion agent in the resin composition for laser engraving of the present invention may vary greatly with the magnitude of the molecular extinction coefficient inherent to the molecule, but the content is preferably 0.01 to 30 mass %, more preferably 0.05 to 20 mass %, and particularly preferably 0.1 to 10 mass %, relative to the total mass of the resin composition.

### (Component F) Alcohol Exchange Reaction Catalyst

The resin composition of the present invention preferable comprises (Component F) an alcohol exchange reaction catalyst in order to promote formation of the crosslinked structure between Component A and Component C, or between Component A and Component E described below.

Any (Component F) alcohol exchange reaction catalyst may be used without any restrictions as long as it is usually used as a reaction catalyst during silane coupling reaction.

(Component F-1) An acidic catalyst or basic catalyst and (Component F-2) a metal complex catalyst are explained below in this order. The basic catalyst of Component F-1 does not include a compound of Component C.

### (Component F-1) Acidic Catalyst or Basic Catalyst

As the acidic catalyst and the basic catalyst, it is preferable to use an acidic or basic compound as it is or in the form of a solution in which it is dissolved in a solvent such as water or an organic solvent (hereinafter, called an acidic catalyst or basic catalyst respectively). The concentration when dissolved in a solvent is not particularly limited, and it may be selected appropriately according to the properties of the acidic or basic compound used, desired catalyst content, etc.

The type of acidic catalyst and basic catalyst is not particularly limited; specific examples thereof include, as the acidic catalyst, a hydrogen halide such as hydrochloric acid, nitric acid, sulfuric acid, sulfurous acid, hydrogen sulfide, perchloric acid, hydrogen peroxide, carbonic acid, a carboxylic acid such as formic acid or acetic acid, a substituted carboxylic acid in which R of the structural formula RCOOH is substituted with another element or substituent, a sulfonic acid such as benzenesulfonic acid, phosphoric acid, a heteropoly acid, and an inorganic solid acid and, as the basic catalyst, an ammoniacal base such as aqueous ammonia, an amine such as ethylamine or aniline, an alkali metal hydroxide, an alkali metal alkoxide, an alkaline earth oxide, a quaternary ammonium salt compound, and a quaternary phosphonium salt compound.

Examples of the amines used as the basic catalyst in the present invention are listed below.

Examples of the amines which does not comprise a mercapto group, a hydrolyzable silyl group, or a silanol group include the compounds (a) to (e) below.

(a) a hydrogenated nitrogen compound such as hydrazine;

(b) monoamines or polyamines, such as diamines or triamines, which is primary, secondary, or tertiary amines of an aliphatic, aromatic, or alicyclic or amines;

(c) monoamines or polyamines which is a condensed ring-containing cyclic amine having at least one nitrogen atom in a ring skeleton;

(d) an oxygen-containing amine such as an amino acid, an amide, an alcoholamine, an ether amine, an imide or a lactam; and

(e) a heteroelement-containing amine having a heteroatom such as O, S or Se.

Therefore, the above-mentioned amine that can be used as the basic catalyst is preferably a compound in which an aliphatic or alicyclic saturated or unsaturated hydrocarbon group, an aromatic hydrocarbon group, an oxygen-containing and/or sulfur-containing and/or selenium-containing hydrocarbon group, etc. is bonded to one or more nitrogen atoms. From the viewpoint of film strength after thermal crosslinking, the pKaH (acid dissociation constant of conjugated acid) range that is preferable as the amine is preferably 7 or greater, and more preferably 10 or greater.

Among the acidic catalysts and basic catalysts, from the viewpoint of an alcohol exchange reaction in the film progressing promptly, methanesulfonic acid, p-toluenesulfonic acid, pyridinium p-toluenesulfonate, dodecylbenzenesulfonic acid, phosphoric acid, phosphonic acid, acetic acid, 1,8-diazabicyclo[5.4.0]undec-7-ene, 1,5-diazabicyclo[4.3.0]non-5-ene, and 1,1,3,3-tetramethylguanidine are preferable, and methanesulfonic acid, p-toluenesulfonic acid, phosphoric acid, 1,8-diazabicyclo[5.4.0]undec-7-ene, and 1,5-diazabicyclo[4.3.0]non-5-ene are particularly preferable.

### (Component F-2) Metal Complex Catalyst

(Component F-2) The metal complex catalyst that can be used as an alcohol exchange reaction catalyst in the present invention is preferably constituted from a metal element selected from Groups 2A, 4A, 5A and 3B of the periodic table and an oxo or hydroxy oxygen compound selected from β-diketones, ketoesters, hydroxycarboxylic acids and esters thereof, amino alcohols, and enolic active hydrogen compounds.

Furthermore, among the constituent metal elements, a Group 2A element such as Mg, Ca, Sr, or Ba, a Group 4A element such as Ti or Zr, a Group 5A element such as V, Nb, or Ta, and a Group 3B element such as Al or Ga are preferable, and they form a complex having an excellent catalytic effect. Among them, a complex obtained from Zr, Al, or Ti is excellent and preferable, ethyl orthotitanate, etc. is more preferable.

In the present invention, examples of the oxo or hydroxy oxygen-containing compound constituting a ligand of the above-mentioned metal complex include β-diketones such as acetylacetone (also known as 2,4-pentanedione), and 2,4-heptanedione, ketoesters such as methyl acetoacetate, ethyl acetoacetate, and butyl acetoacetate, hydroxycarboxylic acids and esters thereof such as lactic acid, methyl lactate, salicylic acid, ethyl salicylate, phenyl salicylate, malic acid, tartaric acid, and methyl tartarate, ketoalcohols such as 4-hydroxy-4-methyl-2-pentanone, 4-hydroxy-2-pentanone, 4-hydroxy-4-methyl-2-pentanone, and 4-hydroxy-2-heptanone, amino alcohols such as monoethanolamine, N,N-dimethylethanolamine, N-methylmonoethanolamine, diethanolamine, and triethanolamine, enolic active compounds such as methylolmelamine, methylolurea, methylolacrylamide, and diethyl malonate ester, and compounds having a substituent on the methyl group, methylene group, or carbonyl carbon of acetylacetone (also known as 2,4-pentanedione).

They have excellent stability in an aqueous coating solution and an excellent effect in promoting gelling in a sol-gel reaction when drying by heating, and among them aluminum ethylacetoacetate diisopropylate, aluminum tris(ethylacetoacetate), a di(acetylacetonato)titanium complex salt, and zirconium tris(ethylacetoacetate) are particularly preferable.

The resin composition of the present invention may comprise one type of (Component F) the alcohol exchange reaction catalyst or two or more types thereof in combination.

The content of (Component F) the alcohol exchange reaction catalyst in the resin composition is preferably 0.1 to 5 mass % relative to the total solids content, more preferably 0.3 to 3 mass %, and yet more preferably 0.5 to 1.5 mass %.

### (Component G) Silane Coupling Agent

The resin composition of the present invention preferably comprises (Component G) a silane coupling agent. Component G does not include a compound of Component C.

In the present invention, a functional group in which at least one of an alkoxy group and a halogen group is directly bonded to an Si atom is called a silane coupling group, and a compound having at least one of these silane coupling groups per molecule is called a silane coupling agent. The silane coupling group (hereinafter, also called a silanol group or a hydrolyzable silyl group) is preferably one in which at least two alkoxy groups or halogen atoms are directly bonded to an Si atom, and particularly preferably one in which at least three thereof are directly bonded thereto.

In the resin composition of the present invention, if the reactive functional group of Component A is for example a hydroxy group (—OH), the silane coupling group of Component G undergoes an alcohol exchange reaction with this hydroxy group, thus forming a crosslinked structure. As a result, Component A molecules are three-dimensionally crosslinked together via the silane coupling agent. It is also possible for Component G molecules to together form a crosslinked structure.

It is essential for Component G to have, as the functional group directly bonded to an Si atom, at least one functional group among an alkoxy group and a halogen atom and, from the viewpoint of ease of handling the compound, one having an alkoxy group is preferable.

From the viewpoint of rinsing properties and printing durability, the alkoxy group is preferably an alkoxy group having 1 to 30 carbons, more preferably an alkoxy group having 1 to 15 carbons, and particularly preferably an alkoxy group having 1 to 5 carbons.

Furthermore, examples of the halogen atom include an F atom, a Cl atom, a Br atom, and an I atom, and from the viewpoint of ease of synthesis and stability, a Cl atom and a Br atom are preferable, and a Cl atom is more preferable.

From the viewpoint of a good balance being maintained between the degree of crosslinking and the flexibility of a film, the silane coupling agent in the present invention has at least two of the silane coupling groups per molecule, more preferably at least two but no greater than ten groups, yet more preferably at least two but no greater than five groups, and particularly preferably at least two but no greater than four groups.

When there are at least two silane coupling groups, the silane coupling groups are preferably linked via a linking group. Examples of the linking group include a di- or higher-valent organic group optionally having a heteroatom or a substituent such as a hydrocarbon, and in terms of high engraving sensitivity a linking group containing a heteroatom (N, S, O) is preferable, and one containing an S atom is particularly preferable.

From such a viewpoint, the silane coupling agent in the present invention is desirably a compound having in the molecule two silane coupling groups in which, as an alkoxy group, a methoxy group or an ethoxy group, and in particular a methoxy group, is bonded to an Si atom, these silane coupling groups being bonded via an alkylene group containing a heteroatom (particularly preferably an S atom). More specifically, one having a linking group containing a sulfide group is preferable.

Furthermore, other preferred modes of the linking group via which the silane coupling groups are linked include a linking group having an oxyalkylene group. Due to the linking group containing an oxyalkylene group, the engraving residue rinsing properties after laser engraving improve. The oxyalkylene group is preferably an oxyethylene group, and more preferably a polyoxyethylene chain in which a plurality of oxyethylene groups are linked. The total number of oxyethylene groups in the polyoxyethylene chain is preferably 2 to 50, more preferably 3 to 30, and particularly preferably 4 to 15.

Specific examples of the silane coupling agent that can be applied to the present invention include compounds described in paragraph 0072 to paragraph 0084 of JP-A-2011-136455.

The resin composition of the present invention may comprise one type of Component G or two or more types thereof in combination.

The content of Component G in the resin composition is preferably 0.1 to 80 mass % relative to the total solids content, more preferably 1 to 40 mass %, and yet more preferably 5 to 30 mass %. When the content of Component G is in this range, a relief layer having excellent engraving residue rinsing properties and printing durability is obtained.

Various types of components that the resin composition of the present invention can comprise other than Component A to Component G are now explained.

### <Other Additives>

The resin composition for laser engraving of the present invention may comprise as appropriate various types of known additives as long as the effects of the present invention are not inhibited. Examples include a filler, a wax, a process oil, an a metal oxide, an antiozonant, an anti-aging agent, a thermopolymerization inhibitor, a colorant, a plasticizer, and a solvent, and one type thereof may be used on its own or two or more types may be used in combination.

### (Flexographic Printing Plate Precursor for Laser Engraving)

A first embodiment of the flexographic printing plate precursor for laser engraving of the present invention comprises a relief-forming layer formed from the resin composition for laser engraving of the present invention.

A second embodiment of the flexographic printing plate precursor for laser engraving of the present invention comprises a crosslinked relief-forming layer formed by crosslinking a relief-forming layer formed from the resin composition for laser engraving of the present invention.

In the present invention, the ‘flexographic printing plate precursor for laser engraving’ means both or one of a flexographic printing plate precursor having a crosslinkable relief-forming layer formed from the resin composition for laser engraving in a state before being crosslinked and a flexographic printing plate precursor in a state in which it is cured by light and/or heat.

The flexographic printing plate precursor for laser engraving of the present invention is a flexographic printing plate precursor having a crosslinkable relief-forming layer cured by heat.

The flexographic printing plate precursor of the present invention preferably has a thermally crosslinked relief-forming layer.

In the present invention, the ‘relief-forming layer’ means a layer in a state before being crosslinked, that is, a layer formed from the resin composition for laser engraving of the present invention, which may be dried as necessary.

In the present invention, the “crosslinked relief-forming layer” refers to a layer obtained by crosslinking the aforementioned relief-forming layer. The crosslinking can be performed by light and/or heat, and the crosslinking by heat is preferable. Moreover, the crosslinking is not particularly limited only if it is a reaction that cures the resin composition, and is a general idea that includes the crosslinked structure by the reaction of Component A with each other, and the reaction of Component A with other Component. When a polymerizable compound is used, the crosslinking includes a crosslinking by polymerization of polymerizable compounds.

The ‘flexographic printing plate’ is made by laser engraving the flexographic printing plate precursor having the crosslinked relief-forming layer.

Moreover, in the present invention, the ‘relief layer’ means a layer of the flexographic printing plate formed by engraving using a laser, that is, the crosslinked relief-forming layer after laser engraving.

A flexographic printing plate precursor for laser engraving of the present invention comprises a relief-forming layer formed from the resin composition for laser engraving of the present invention, which has the above-mentioned components. The (crosslinked) relief-forming layer is preferably provided above a support.

The (crosslinked) flexographic printing plate precursor for laser engraving may further comprise, as necessary, an adhesive layer between the support and the (crosslinked) relief-forming layer and, above the relief-forming layer, a slip coat layer and a protection film.

### <Relief-Forming Layer>

The relief-forming layer is a layer formed from the resin composition for laser engraving of the present invention, and is a crosslinkable layer.

As a mode in which a flexographic printing plate is prepared using the flexographic printing plate precursor for laser engraving, a mode in which a flexographic printing plate is prepared by crosslinking a relief-forming layer to thus form a flexographic printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a flexographic printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate producing or printing or may be placed and immobilized thereon, and a support is not always required.

A case in which the relief-forming layer is mainly formed in a sheet shape is explained as an example below.

### <Support>

A material used for the support of the flexographic printing plate precursor for laser engraving is not particularly limited, but one having high dimensional stability is preferably used, and examples thereof include metals such as steel, stainless steel, or aluminum, plastic resins such as a polyester (e.g. polyethylene terephthalate (PET), polybutylene terephthalate (PBT), or polyacrylonitrile (PAN)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers.

Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### <Process for Producing Flexographic Printing Plate Precursor for Laser Engraving>

The process for producing a flexographic printing plate precursor for laser engraving is not particularly limited, and examples thereof include a method in which a resin composition for laser engraving is prepared, solvent is removed from this coating solution composition for laser engraving, and it is then melt-extruded onto a support. Alternatively, a method may be employed in which a resin composition for laser engraving is cast onto a support, and this is dried in an oven to thus remove solvent from the resin composition.

Among them, the process for producing a flexographic printing plate precursor for laser engraving of the present invention is preferably a production process comprising a layer formation step of forming a relief-forming layer from the composition comprising at least Component A to Component D.

Furthermore, the process for producing a flexographic printing plate precursor for laser engraving of the present invention having a crosslinked relief-forming layer formed by crosslinking the relief-forming layer is preferably a production process comprising a layer formation step of forming a relief-forming layer from a composition comprising at least Component A to Component D and a crosslinking step of crosslinking the relief-forming layer by means of heat to thus obtain a flexographic printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for producing the flexographic printing plate precursor for laser engraving of the present invention preferably comprises a layer formation step of forming a relief-forming layer from the composition comprising at least Component A to Component D.

Preferred examples of a method for forming the relief-forming layer include a method in which the composition comprising at least Component A to Component D is prepared, solvent is removed as necessary from this composition, and it is then melt-extruded onto a support and a method in which the composition comprising at least Component A to Component D is prepared, the composition is cast onto a support, and this is dried in an oven to thus remove solvent.

The composition (the resin composition for laser engraving) for laser engraving may be produced by, for example, dissolving or dispersing Component A to Component D, and Component E to Component G, etc. as optional components, in an appropriate solvent.

The composition that can suitably be used for preparation of a relief-forming layer may comprise a solvent.

From the viewpoint of the solubility of each component, the solvent used for preparing the composition preferably mainly comprises an aprotic organic solvent. More specifically, it is preferably used at aprotic organic solvent/protic organic solvent=100/0 to 50/50 (ratio by mass), more preferably 100/0 to 70/30, and particularly preferably 100/0 to 90/10.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of a protic organic solvent include methanol, ethanol, 1-propanol, 2-propanol, 1-butanol, 1-methoxy-2-propanol, ethylene glycol, diethylene glycol, and 1,3-propanediol.

Among them, propylene glycol monomethyl ether acetate is preferable.

### <Crosslinking Step>

The process for producing a flexographic printing plate precursor for laser engraving of the present invention is preferably a production process comprising a crosslinking step of crosslinking the relief-forming layer by means of heat to thus obtain a flexographic printing plate precursor having a crosslinked relief-forming layer.

In the crosslinking step, by heating a flexographic printing plate precursor, a relief-forming layer can be crosslinked (a step of crosslinking by heat).

As heating means for carrying out crosslinking by heat, there can be cited a method in which a printing plate precursor is heated in a hot air oven or a far-infrared oven for a predetermined period of time and a method in which it is put into contact with a heated roller for a predetermined period of time.

Due to the relief-forming layer being crosslinked, firstly, a relief formed after laser engraving becomes sharp and, secondly, tackiness of engraving residue formed when laser engraving is suppressed. If an uncrosslinked relief-forming layer is laser-engraved, residual heat transmitted to an area around a laser-irradiated part easily causes melting or deformation of a part that is not targeted, and a sharp relief layer cannot be obtained in some cases. Furthermore, in terms of general properties of a material, the lower the molecular weight, the more easily it becomes a liquid than a solid, that is, there is a tendency for tackiness to increase. Engraving residue formed when engraving a relief-forming layer tends to have higher tackiness as larger amounts of low-molecular-weight materials are used. Since a polymerizable compound, which is a low-molecular-weight material, becomes a polymer by crosslinking, the tackiness of the engraving residue formed tends to decrease.

When the crosslinking step is a step of carrying out crosslinking by heat, although there is the advantage that particularly expensive equipment is not needed, since a printing plate precursor reaches a high temperature, it is necessary to carefully select the starting materials used while taking into consideration the possibility that a thermoplastic polymer, which becomes soft at high temperature, will deform during heating, etc.

During thermal crosslinking, not only a thermopolymerization initiator, but also a representative vulcanizing agent may also be used for crosslinking. Thermal crosslinking may also be carried out by adding a heat-curable resin such as for example an epoxy resin as a crosslinking component to a layer.

### (Flexographic Printing Plate and Process for Making Same)

The process for making a flexographic printing plate of the present invention preferably comprises an engraving step of laser-engraving the flexographic printing plate precursor for laser engraving of the present invention having a crosslinked relief-forming layer.

The process for making a flexographic printing plate of the present invention more preferably comprises a layer formation step of forming a relief-forming layer from a composition comprising at least Component A to Component D, a crosslinking step of crosslinking the relief-forming layer by means of heat to thus obtain a flexographic printing plate precursor having a crosslinked relief-forming layer, and an engraving step of laser-engraving the flexographic printing plate precursor having a crosslinked relief-forming layer.

The flexographic printing plate of the present invention is a flexographic printing plate having a relief layer that is obtained by crosslinking and laser-engraving the relief-forming layer of the flexographic printing plate precursor for laser engraving of the present invention, and is preferably a flexographic printing plate made by the process for making a flexographic printing plate of the present invention.

The flexographic printing plate of the present invention may suitably be used when printing is carried out using various inks such as an aqueous ink, a solvent ink, or a UV ink.

The layer formation step and the crosslinking step of the process for making a flexographic printing plate of the present invention have the same meanings as those of the layer formation step and the crosslinking step of the process for producing a flexographic printing plate precursor for laser engraving, and preferred embodiments are also the same.

### <Engraving Step>

The process for producing a flexographic printing plate of the present invention preferably comprises an engraving step of laser-engraving the flexographic printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is yet more preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, ‘Applied Laser Technology’ The Institute of Electronics and Communication Engineers, etc.

Moreover, as plate making equipment comprising a fiber-coupled semiconductor laser that can be used suitably in the process for making a flexographic printing plate employing the flexographic printing plate precursor of the present invention, those described in detail in JP-A-2009-172658 and JP-A-2009-214334 can be cited.

The process for making a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraved residue is attached to the engraved surface, a rinsing step of washing off engraved residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraved residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 6, more preferably at least 6.5, and yet more preferably at least 11. The pH of the rinsing liquid is preferably no greater than 14, more preferably no greater than 13.5, and yet more preferably no greater than 13.1. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraved residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, amphoteric surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 mass % relative to the total mass of the rinsing liquid, and more preferably 0.05 to 10 mass %.

The flexographic printing plate of the present invention having a relief layer above the surface of an optional substrate such as a support may be produced as described above.

From the viewpoint of satisfying suitability for various aspects of printing, such as abrasion resistance and ink transfer properties, the thickness of the relief layer of the flexographic printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The flexographic printing plate of the present invention is particularly suitable for printing in a flexographic printer using an aqueous ink, but printing is also possible when using any ink such as an aqueous ink, an oil-based ink, or a UV ink in a letterpress printer, and printing is also possible in a flexographic printer using a UV ink. The flexographic printing plate of the present invention has a high insolubilization ratio with respect to solvent and excellent surface tackiness, sensitivity, engraving residue rinsing properties, ink transfer properties, and printing durability.

In accordance with the present invention, there can be provided a resin composition for laser engraving that can give a flexographic printing plate having a high insolubilization ratio with respect to solvent and excellent surface tackiness, sensitivity, engraving residue rinsing properties, ink transfer properties, and printing durability, a flexographic printing plate precursor and a process for producing same employing the resin composition for laser engraving, and a flexographic printing plate and a process for making same.

### EXAMPLES

The present invention is explained in further detail below by reference to Examples and Comparative examples, but the present invention should not be construed as being limited to these Examples. Furthermore, ‘parts’ in the description below means ‘parts by mass’, and ‘%’ means ‘% by mass’, unless otherwise specified.

Unless otherwise specified, the weight-average molecular weight (Mw) of a polymer in the Examples is a value measured by GPC and calculated on a polystyrene basis.

### Production Example 1

### Preparation of A-1

A separable flask equipped with a thermometer, a stirrer, and a reflux condenser was charged with 400 parts of a polycarbonate diol (‘PCDL (registered trademark) L4672’, Asahi Kasei Chemicals: number-average molecular weight 1,990, OH value 56.4 mg KOH/g), 32 parts of Blemmer GLM (glycerol monomethacrylate; NOF Corporation), and 30.83 parts of tolylene diisocyanate, and a reaction was carried out while heating at 80° C. for about 3 hours. Following this, 10.5 parts of n-butyl isocyanate (Wako Pure Chemical Industries, Ltd.) was added, and a reaction was carried out for a further approximately 2 hours, thus giving A-1 having a methacryloxy group (methacrylic group content: about 1 meq/g) in a side chain and a weight-average molecular weight of about 80,000. A-1 was a liquid at 20° C.

### Production Example 2

### Preparation of A-2

A separable flask equipped with a thermometer and a stirrer was charged with 400 parts of a polycarbonate diol (‘PCDL (registered trademark) L4672’, Asahi Kasei Chemicals: number-average molecular weight 1,990, OH value 56.4 mg KOH/g) and 44 parts of triethylamine (Tokyo Chemical Industry Co., Ltd.) and cooled in an ice bath at 0° C., 39 parts of acryloyl chloride

(Tokyo Chemical Industry Co., Ltd.) was slowly added dropwise so as to maintain the flask internal temperature at 5° C. or below, the temperature was then returned to normal temperature, and stirring was carried out for 4 hours. The mixture was extracted with water and ethyl acetate, and the organic layer was concentrated, thus giving A-2 having an acryloyloxy group at both termini and a weight-average molecular weight of about 2,500. A-2 was a liquid at 20° C.

### Production Example 3

### Preparation of A-3

A separable flask equipped with a thermometer and a stirrer was charged with 200 parts of propylene glycol monomethyl ether, 100 parts of methacrylic acid, 100 parts of methyl methacrylate, and 1 part of V-601 (described later) and heated at 80° C. for 4.5 hours, then charged with 165 parts of glycidyl methacrylate (Wako Pure Chemical Industries, Ltd.) and 5 parts of tetraethylammonium bromide (Tokyo Chemical Industry Co., Ltd.), and stirred at 90° C. for 9 hours. The mixture was reprecipitated with water and dried without heating, thus giving A-3 having a methacryloxy group in a side chain and a weight-average molecular weight of about 25,000. A-3 was a solid at 20° C.

### Example 1

### 1. Preparation of Resin Composition for Laser Engraving

A three-necked flask equipped with a stirring blade and a condenser was charged with 50 parts of Shikoh UV-3000B (polymer having an acryloyloxy group at both termini and having a urethane bond, liquid at 20° C., Mw≈18,000, The Nippon Synthetic Chemical Industry Co., Ltd.) as the oligomer or polymer having a (meth)acryloyloxy group in the molecule (Component A) and 50 parts of propylene glycol monomethyl ether acetate as a solvent, heating was carried out at 60° C. for 1 hour while stirring to thus dissolve the above, the solution was set at 40° C., 10 parts of triethylene glycol dimethacrylate (TEGDMA) (Tokyo Chemical Industry Co., Ltd.) as the ethylenically unsaturated compound (Component B), 3 parts of Ketjen Black EC600JD (carbon black, Lion Corporation) as the photothermal conversion agent (Component E), 5 parts of 3-mercaptopropylmethyldimethoxysilane (product name: KBM-802, Shin-Etsu Chemical Co., Ltd.) as Component C, and 1.2 parts of t-butyl peroxybenzoate (product name: Perbutyl Z, NOF Corporation) as the thermopolymerization initiator (Component D) were further added, and stirring was carried out for 30 minutes. These operations gave coating solution 1 for a crosslinkable relief-forming layer (resin composition 1 for laser engraving) having flowability.

### 2. Production of Flexographic Printing Plate Precursor for Laser Engraving

A spacer (frame) having a predetermined thickness was installed on a PET substrate, and the coating solution 1 for crosslinkable relief-forming layer obtained as described above was gently flow cast so as not to flow out over the spacer (frame), and was dried in an oven at 70° C. for 3 hours. Thereafter, the system was further heated for 3 hours at 90° C. and for another 3 hours at 120° C. to thermally crosslink the relief-forming layer, and thus a crosslinked relief-forming layer having a thickness of approximately 1 mm was provided. Thus, a flexographic printing plate precursor for laser engraving 1 was produced.

### 3. Making Flexographic Printing Plate

The relief-forming layer after crosslinking (crosslinked relief-forming layer) was engraved using the two types of laser below.

As a carbon dioxide laser engraving machine, for engraving by irradiation with a laser, an ML-9100 series high quality CO₂ laser marker (Keyence) was used. A 1 cm square solid printed part was raster-engraved using the carbon dioxide laser engraving machine under conditions of an output of 12 W, a head speed of 200 mm/sec, and a pitch setting of 2,400 DPI, thus forming halftone dots with a highlight of 1% to 10%.

As a semiconductor laser engraving machine, laser recording equipment provided with an SDL-6390 fiber-coupled semiconductor laser (FC-LD) (JDSU, wavelength 915 nm) with a maximum power of 8.0 W was used. A 1 cm square solid printed part was raster-engraved using the semiconductor laser engraving machine under conditions of a laser output of 7.5 W, a head speed of 409 mm/sec, and a pitch setting of 2,400 DPI, thus forming halftone dots with a highlight of 1% to 10%.

The thickness of the relief layer of the flexographic printing plate thus obtained was about 1 mm.

### Example 2

### 1. Preparation of Crosslinkable Resin Composition for Laser Engraving

Coating solution 2 for a crosslinkable relief-forming layer (resin composition for laser engraving) was prepared in the same manner as in Example 1 except that 0.8 parts of DBU (1,8-diazabicyclo[5.4.0]-7-undecene, Tokyo Chemical Industry Co., Ltd.) was added as the alcohol exchange reaction catalyst (Component F).

### 2. Preparation of Flexographic Printing Plate Precursor for Laser Engraving

Flexographic printing plate precursor 2 for laser engraving of Example 2 was obtained in the same manner as in Example 1 except that coating solution 1 for a crosslinkable relief-forming layer in Example 1 was changed to coating solution 2 for a crosslinkable relief-forming layer.

### 3. Preparation of Flexographic Printing Plate

Flexographic printing plate 2 of Example 2 was obtained by thermally crosslinking a relief-forming layer of flexographic printing plate precursor 2 for laser engraving of Example in the same manner as in Example 1 and then engraving it to thus form a relief layer.

The relief layer of flexographic printing plate 2 had a thickness of about 1 mm.

### Example 3

### 1. Preparation of Crosslinkable Resin Composition for Laser Engraving

Coating solution 3 for a crosslinkable relief-forming layer (resin composition for laser engraving) was prepared in the same manner as in Example 2 except that 5 parts of G-1 was added as the silane coupling agent (Component G).

### 2. Preparation of Flexographic Printing Plate Precursor for Laser Engraving

Flexographic printing plate precursor 3 for laser engraving of Example 3 was obtained in the same manner as in Example 2 except that coating solution 2 for a crosslinkable relief-forming layer in Example 2 was changed to coating solution 3 for a crosslinkable relief-forming layer.

### 3. Preparation of Flexographic Printing Plate

Flexographic printing plate 3 of Example 3 was obtained by thermally crosslinking a relief-forming layer of flexographic printing plate precursor 3 for laser engraving of Example in the same manner as in Example 2 and then engraving it to thus form a relief layer.

The relief layer of flexographic printing plate 3 had a thickness of about 1 mm.

### Examples 4 to 29 and Comparative Examples 1 to 9

### 1. Preparation of Crosslinkable Resin Composition for Laser Engraving

Coating solutions 4 to 29 for a crosslinkable relief-forming layer (crosslinkable resin compositions for laser engraving) and comparative coating solutions 1 to 9 for a crosslinkable relief-forming layer (crosslinkable resin compositions for laser engraving) were prepared in the same manner as in Example 3 except that the materials used in Example 3 were changed to the materials described in Table 1 below. In Table 1 ‘-’ means that none is contained.

### 2. Preparation of Flexographic Printing Plate Precursor for Laser Engraving

Flexographic printing plate precursors 4 to 29 for laser engraving of the Examples and flexographic printing plate precursors 1 to 9 for laser engraving of the Comparative Examples were obtained in the same manner as in Example 3 except that coating solution 3 for a crosslinkable relief-forming layer in Example 3 was changed to each of the coating solutions 4 to 28 for a crosslinkable relief-forming layer and comparative coating solutions 1 to 9 for a crosslinkable relief-forming layer.

### 3. Preparation of Flexographic Printing Plate

Flexographic printing plates 4 to 29 of the Examples and flexographic printing plates 1 to 9 of the Comparative Examples were obtained by thermally crosslinking the relief-forming layers of the flexographic printing plate precursors 4 to 28 for laser engraving of the Examples and flexographic printing plate precursors 1 to 9 for laser engraving of the Comparative Examples and then engraving them to thus form a relief layer.

The relief layers of these flexographic printing plates had a thickness of about 1 mm.

Details of Component A to Component G and additives used in each of the Examples and Comparative Examples are as follows.

### (Component A)

Shikoh UV-3000B (polymer having an acryloyloxy group at both termini and having a urethane bond, liquid at 20° C., Mw≈18,000, The Nippon Synthetic Chemical Industry Co., Ltd.)
Shikoh UV-3700B (polymer having an acryloyloxy group at both termini and having a urethane bond (acryloyloxy group-containing polyurethane resin), plastomer at 20° C., Mw≈38,000, The Nippon Synthetic Chemical Industry Co., Ltd.)
Shikoh UV-3310B (oligomer having an acryloyloxy group at both termini and having a urethane bond (acryloyloxy group-containing urethane oligomer), plastomer at 20° C., Mw≈5,000, The Nippon Synthetic Chemical Industry Co., Ltd.)
Shikoh UV-2000B (polymer having an acryloyloxy group at both termini and having a urethane bond (acryloyloxy group-containing urethane polymer), plastomer at 20° C., Mw≈13,000, The Nippon Synthetic Chemical Industry Co., Ltd.)
Shikoh UV-3630 ID80 (polymer having an acryloyloxy group at both temini and having a urethane bond and a hydrogenated polybutadiene structure (acryloyloxy group-containing aliphatic urethan polymer), plastomer at 20° C., Mw≈49,000, The Nippon Synthetic Chemical Industry Co., Ltd.)
EBECRYL 885 (oligomer having an acryloyloxy group at both termini of a polyester skeleton (acryloyloxy group-containing polyester oligomer), plastomer at 20° C., Mw≈6,000, The Nippon Synthetic Chemical Industry Co., Ltd.)
Comparative acrylic resin 1: cyclohexyl methacrylate/2-hydroxyethyl methacrylate 70/30 (mole %) copolymer, solid at 20° C., Mw=15,000
Comparative acrylic resin 2: cyclohexyl methacrylate/allyl methacrylate 70/30 (mole %) copolymer, solid at 20° C., Mw=20,000
S-LEC BM-2: polyvinyl butyral, solid at 20° C., Mw=52,000, Sekisui Chemical Co., Ltd.
TR2000: styrene/butadiene block copolymer, thermoplastic elastomer, JSR PCDL (registered trademark) L4672: polycarbonate diol, Asahi Kasei Chemicals, number-average molecular weight 1,990, OH value 56.4 mg KOH/g

### (Component B)

TEGDMA: triethylene glycol dimethacrylate, Tokyo Chemical Industry Co., Ltd.
A-BPE-4: ethoxylated bisphenol A diacrylate, Shin-Nakamura Chemical Co., Ltd.
B-1: compound represented by Formula (B-1) below: Shin-Nakamura Chemical Co., Ltd.

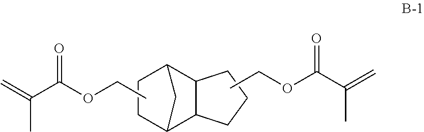

### (Component C)

### 3-Mercaptopropylmethyldimethoxysilane: Shin-Etsu Chemical Co., Ltd.

### 3-Mercaptopropyltrimethoxysilane: Shin-Etsu Chemical Co., Ltd.

### 3-Aminopropyltrimethoxysilane: Shin-Etsu Chemical Co., Ltd.

### 3-Aminopropyltriethoxysilane: Shin-Etsu Chemical Co., Ltd.

N-2-(Aminoethyl)-3-aminopropylmethyldimethoxysilane: Shin-Etsu Chemical Co., Ltd.
N-2-(Aminoethyl)-3-aminopropyltrimethoxysilane: Shin-Etsu Chemical Co., Ltd.
N-2-(Aminoethyl)-3-aminopropyltriethoxysilane: Shin-Etsu Chemical Co., Ltd.
N-Phenyl-3-aminopropyltrimethoxysilane: Shin-Etsu Chemical Co., Ltd.

### (Component D)

Perbutyl Z: t-butyl peroxybenzoate, NOF Corporation
Percumyl D: dicumyl peroxide, NOF Corporation
V-601: dimethyl-2,2′-azobis(2-methylpropionate), Wako Pure Chemical Industries, Ltd.

### (Component E)

Ketjen Black EC600JD: carbon black, Lion Corporation

### (Component F)

DBU: 1,8-diazabicyclo-[5.4.0]-7-undecene, Tokyo Chemical Industry Co., Ltd.
Phosphoric acid: Tokyo Chemical Industry Co., Ltd.
Al(acac)₃: aluminum acetylacetonate, Tokyo Chemical Industry Co., Ltd.
Epomin SP-006: compound having the structural formula below, polyethyleneimine, Nippon Shokubai Co., Ltd.

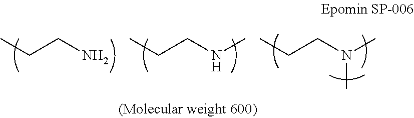

### (Component G)

G-1: compound represented by Formula (G-1) below (synthesized in accordance with a method described in paragraphs 0059 to 0084 of JP-A-2011-136455.)

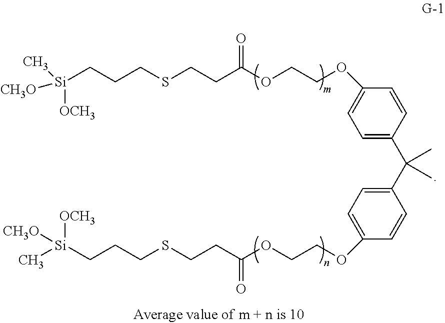

### Z-6920: S₂(C₃H₆Si(OC₂H₅)₃)₂, Dow Corning Toray

### Z-6940: S₄(C₃H₆Si(OC₂H₅)₃)₂, Dow Corning Toray

### 4. Evaluation of Flexographic Printing Plate

Evaluation of the performance of the flexographic printing plates was carried out in terms of the items below, and the results are shown in Table 1. The evaluation results when engraving was carried out using a carbon dioxide laser and the evaluation results when engraving was carried out using a semiconductor laser were the same.

### 4-1. Evaluation of Surface Tackiness

A PET film was pressed against the surface of each of the flexographic printing plate precursors obtained in Examples 1 to 28 and Comparative Examples 1 to 9. When the PET film was easily peeled off and there was nothing adhering to the PET film it was evaluated as A, when peeling was slightly difficult but there was nothing adhering to the PET film it was evaluated as B, when peeling was fairly difficult but there was nothing adhering to the PET film it was evaluated as C, and when peeling was difficult and there was material adhering to the PET film it was evaluated as D.

### 4-2. Measurement of Engraving Depth

The ‘engraving depth’ of a relief layer obtained by laser-engraving the relief-forming layer of each of the flexographic printing plate precursors 1 to 28 of the Examples and flexographic printing plate precursors 1 to 9 of the Comparative Examples was measured as follows. The ‘engraving depth’ referred to here means the difference between an engraved position (height) and an unengraved position (height) when a cross-section of the relief layer was examined. The ‘engraving depth’ in the present Examples was measured by examining a cross-section of a relief layer using a VK9510 ultradepth color 3D profile measurement microscope (Keyence Corporation). A large engraving depth means a high engraving sensitivity. The results are given in Table 2 for each of the types of laser used for engraving.

### 4-3. Evaluation of Rinsing Properties

A laser-engraved plate was immersed in water and an engraved part was rubbed using a toothbrush (Clinica Toothbrush Flat, Lion Corporation) 10 times. Subsequently, the presence/absence of residue on the surface of the relief layer was checked using an optical microscope. When there was hardly any residue the evaluation was A, when there was a little residue but there was no practical problem the evaluation was B, and when the residue could not be removed the evaluation was C.

### 4-4. Evaluation of Ink Transfer Properties

After laser engraving and rinsing, a flexographic printing plate that had been obtained was set in a printer (Model ITM-4, IYO KIKAI SEISAKUSHO Co., Ltd.), as the ink Aqua SPZ16 Red aqueous ink (Toyo Ink Manufacturing Co., Ltd.) was used without dilution, printing was carried out continuously using Full Color Form M 70 (Nippon Paper Industries Co., Ltd., thickness 100 μm) as the printing paper, and the degree of ink attachment in a solid printed area on the printed material at 500 m from the start of printing was compared by visual inspection.

With regard to evaluation criteria, one that was uniform without unevenness in density was evaluated as A, one with a little unevenness in density was evaluated as B, one with unevenness was evaluated as D, and a degree midway between B and D was evaluated as C. Furthermore, one that could not be printed up to 500 m was evaluated as D.

### 4-5. Printing Durability

A flexographic printing plate that had been obtained was set in a printer (Model ITM-4, IYO KIKAI SEISAKUSHO Co., Ltd.), as the ink Aqua SPZ16 Red aqueous ink (Toyo Ink Manufacturing Co., Ltd.) was used without dilution, and printing was carried out continuously using Full Color Form M 70 (Nippon Paper Industries Co., Ltd., thickness 100 μm) as the printing paper, and a highlight of 1% to 10% was confirmed for a printed material. The end of printing was defined when there was a halftone dot that was not printed, and the length (meters) of paper that was printed up to the end of printing was used as an index. The larger the value, the better the printing durability.

### 4-6. Measurement of Insolubilization Ratio

About 1 g of the flexographic printing plate precursor obtained in each of Examples 1 to 28 and Comparative Examples 1 to 9 was cut and weighed, immersed in each of water, isopropanol (IPA), and butyl acetate (AcOBu) for 24 hours, taken out, dried at 120° C. for 1 hour, and then weighed again, and change in mass was determined and defined as the insolubilization ratio.

Insolubilization ratio=(mass after immersion and drying/initial mass)×100

The higher the insolubilization ratio, the less it dissolved in the ink and the better the evaluation.

The results are shown in Table 2.

TABLE 1

| | Component A | | | | | | | | | |
|---|---|---|---|---|---|---|---|---|---|---|
| | Oligomer or | | Unsaturated | Urethane | Com- | | Com- | Component | Compo- | Compo- |
| | polymer | Mw | group | bond | ponent B | Component C | ponent D | E | nent F | nent G |
| Ex. 1 | Shikoh UV- | 18,000 | Both termini | Yes | TEGDMA | 3-Mercaptopropylmethyl | Perbutyl Z | Ketjen Black | — | — |
| | 3000B | | | | | dimethoxysilane | | EC600JD | | |
| Ex. 2 | Shikoh UV- | 18,000 | Both termini | Yes | TEGDMA | 3-Mercaptopropylmethyl | Perbutyl Z | Ketjen Black | DBU | — |
| | 3000B | | | | | dimethoxysilane | | EC600JD | | |
| Ex. 3 | Shikoh UV- | 18,000 | Both termini | Yes | TEGDMA | 3-Mercaptopropylmethyl | Perbutyl Z | Ketjen Black | DBU | G-1 |
| | 3000B | | | | | dimethoxysilane | | EC600JD | | |
| Ex. 4 | Shikoh UV- | 18,000 | Both termini | Yes | TEGDMA | 3-Mercaptopropyl | Perbutyl Z | Ketjen Black | DBU | G-1 |
| | 3000B | | | | | trimethoxysilane | | EC600JD | | |
| Ex. 5 | Shikoh UV- | 18,000 | Both termini | Yes | TEGDMA | 3-Aminopropyl | Perbutyl Z | Ketjen Black | DBU | G-1 |
| | 3000B | | | | | trimethoxysilane | | EC600JD | | |
| Ex. 6 | Shikoh UV- | 18,000 | Both termini | Yes | TEGDMA | 3-Aminopropyl | Perbutyl Z | Ketjen Black | DBU | G-1 |
| | 3000B | | | | | triethoxysilane | | EC600JD | | |
| Ex. 7 | Shikoh UV- | 18,000 | Both termini | Yes | TEGDMA | N-2-(Aminoethyl)-3- | Perbutyl Z | Ketjen Black | DBU | G-1 |
| | 3000B | | | | | aminopropylmethyl | | EC600JD | | |
| Ex. 8 | Shikoh UV- | 18,000 | Both termini | Yes | TEGDMA | N-2-(Aminoethyl)- | Perbutyl Z | Ketjen Black | DBU | G-1 |
| | 3000B | | | | | 3-aminopropyl | | EC600JD | | |
| | | | | | | trimethoxysilane | | | | |
| Ex. 9 | Shikoh UV- | 18,000 | Both termini | Yes | TEGDMA | N-2-(Aminoethyl)- | Perbutyl Z | Ketjen Black | DBU | G-1 |
| | 3000B | | | | | 3-aminopropyl | | EC600JD | | |
| | | | | | | triethoxysilane | | | | |
| Ex. 10 | Shikoh UV- | 18,000 | Both termini | Yes | TEGDMA | N-phenyl-3-aminopropyl | Perbutyl Z | Ketjen Black | DBU | G-1 |
| | 3000B | | | | | trimethoxysilane | | EC600JD | | |
| Ex. 11 | Shikoh UV- | 38,000 | Both termini | Yes | TEGDMA | 3-Mercaptopropylmethyl | Perbutyl Z | Ketjen Black | DBU | G-1 |
| | 3700B | | | | | dimethoxysilane | | EC600JD | | |
| Ex. 12 | Shikoh UV- | 13,000 | Both termini | Yes | TEGDMA | 3-Mercaptopropylmethyl | Perbutyl Z | Ketjen Black | DBU | G-1 |
| | 2000B | | | | | dimethoxysilane | | EC600JD | | |
| Ex. 13 | Shikoh UV- | 5,000 | Both termini | Yes | TEGDMA | 3-Mercaptopropylmethyl | Perbutyl Z | Ketjen Black | DBU | G-1 |
| | 3310B | | | | | dimethoxysilane | | EC600JD | | |
| Ex. 14 | A-1 | 80,000 | Side chain | Yes | TEGDMA | 3-Mercaptopropylmethyl | Perbutyl Z | Ketjen Black | DBU | G-1 |
| | | | | | | dimethoxysilane | | EC600JD | | |
| Ex. 15 | EBECRYL | 6,000 | Both termini | — | TEGDMA | 3-Mercaptopropylmethyl | Perbutyl Z | Ketjen Black | DBU | G-1 |
| | 885 | | | | | dimethoxysilane | | EC600JD | | |
| Ex. 16 | A-2 | 2,500 | Both termini | — | TEGDMA | 3-Mercaptopropylmethyl | Perbutyl Z | Ketjen Black | DBU | G-1 |
| | | | | | | dimethoxysilane | | EC600JD | | |
| Ex. 18 | Shikoh UV- | 18,000 | Both termini | Yes | A-BPE-4 | 3-Mercaptopropylmethyl | Perbutyl Z | Ketjen Black | DBU | G-1 |
| | 3000B | | | | | dimethoxysilane | | EC600JD | | |
| Ex. 19 | Shikoh UV- | 18,000 | Both termini | Yes | B-1 | 3-Mercaptopropylmethyl | Perbutyl Z | Ketjen Black | DBU | G-1 |
| | 3000B | | | | | dimethoxysilane | | EC600JD | | |
| Ex. 20 | Shikoh UV- | 49,000 | Both termini | Yes | TEGDMA | 3-Mercaptopropylmethyl | Perbutyl Z | Ketjen Black | DBU | G-1 |
| | 3630ID80 | | | | | dimethoxysilane | | EC600JD | | |
| Ex. 21 | Shikoh UV- | 18,000 | Both termini | Yes | TEGDMA | 3-Mercaptopropylmethyl | Percumyl | Ketjen Black | DBU | G-1 |
| | 3000B | | | | | dimethoxysilane | D | EC600JD | | |
| Ex. 22 | Shikoh UV- | 18,000 | Both termini | Yes | TEGDMA | 3-Mercaptopropylmethyl | V-601 | Ketjen Black | DBU | G-1 |
| | 3000B | | | | | dimethoxysilane | | EC600JD | | |
| Ex. 23 | Shikoh UV- | 18,000 | Both termini | Yes | TEGDMA | 3-Mercaptopropylmethyl | Perbutyl Z | Ketjen Black | Epomin | G-1 |
| | 3000B | | | | | dimethoxysilane | | EC600JD | | |
| Ex. 24 | Shikoh UV- | 18,000 | Both termini | Yes | TEGDMA | 3-Mercaptopropylmethyl | Perbutyl Z | Ketjen Black | Phos- | G-1 |
| | 3000B | | | | | dimethoxysilane | | EC600JD | phoric | |
| | | | | | | | | | acid | |
| Ex. 25 | Shikoh UV- | 18,000 | Both termini | Yes | TEGDMA | 3-Mercaptopropylmethyl | Perbutyl Z | Ketjen Black | Al(acac)3 | G-1 |
| | 3000B | | | | | dimethoxysilane | | EC600JD | | |
| Ex. 26 | Shikoh UV- | 18,000 | Both termini | Yes | TEGDMA | 3-Mercaptopropylmethyl | Perbutyl Z | Ketjen Black | DBU | Z-6920 |
| | 3000B | | | | | dimethoxysilane | | EC600JD | | |
| Ex. 27 | Shikoh UV- | 18,000 | Both termini | Yes | TEGDMA | 3-Mercaptopropylmethyl | Perbutyl Z | Ketjen Black | DBU | Z-6940 |
| | 3000B | | | | | dimethoxysilane | | EC600JD | | |
| Ex. 28 | Shikoh UV- | 18,000 | Both termini | Yes | TEGDMA | 3-Mercaptopropylmethyl | Perbutyl Z | — | DBU | G-1 |
| | 3000B | | | | | dimethoxysilane | | | | |
| Ex. 29 | A-3 | 25,000 | Side chain | — | TEGDMA | 3-Mercaptopropylmethyl | Perbutyl Z | Ketjen Black | DBU | G-1 |
| | | | | | | dimethoxysilane | | EC600JD | | |
| Comp. Ex. 1 | — | — | — | — | TEGDMA | 3-Mercaptopropylmethyl | Perbutyl Z | Ketjen Black | DBU | G-1 |
| | | | | | | dimethoxysilane | | EC600JD | | |
| Comp. Ex. 2 | Shikoh UV- | 18,000 | Both termini | Yes | — | 3-Mercaptopropylmethyl | Perbutyl Z | Ketjen Black | DBU | G-1 |
| | 3000B | | | | | dimethoxysilane | | EC600JD | | |
| Comp. Ex. 3 | Shikoh UV- | 18,000 | Both termini | Yes | TEGDMA | — | Perbutyl Z | Ketjen Black | DBU | G-1 |
| | 3000B | | | | | | | EC600JD | | |
| Comp. Ex. 4 | Shikoh UV- | 18,000 | Both termini | Yes | TEGDMA | 3-Mercaptopropylmethyl | — | Ketjen Black | DBU | G-1 |
| | 3000B | | | | | dimethoxysilane | | EC600JD | | |
| Comp. Ex. 5 | Comp. | 15,000 | — | — | TEGDMA | 3-Mercaptopropylmethyl | Perbutyl Z | Ketjen Black | DBU | G-1 |
| | acrylic | | | | | dimethoxysilane | | EC600JD | | |
| | resin 1 | | | | | | | | | |
| Comp. Ex. 6 | Comp. | 20,000 | — | — | TEGDMA | 3-Mercaptopropylmethyl | Perbutyl Z | Ketjen Black | DBU | G-1 |
| | acrylic | | | | | dimethoxysilane | | EC600JD | | |
| | resin 2 | | | | | | | | | |
| Comp. Ex. 7 | S-LEC | 52,000 | — | — | TEGDMA | 3-Mercaptopropylmethyl | Perbutyl Z | Ketjen Black | DBU | G-1 |
| | BM-2 | | | | | dimethoxysilane | | EC600JD | | |
| Comp. Ex. 8 | TR2000 | | — | — | TEGDMA | 3-Mercaptopropylmethyl | Perbutyl Z | Ketjen Black | DBU | G-1 |
| | | | | | | dimethoxysilane | | EC600JD | | |
| Comp. Ex. 9 | PCDL | 1,990 | — | — | TEGDMA | 3-Mercaptopropylmethyl | Perbutyl Z | Ketjen Black | DBU | G-1 |
| | L4672 | | | | | dimethoxysilane | | EC600JD | | |

TABLE 2

| | | | | | | | | Engraving | Engraving |
|---|---|---|---|---|---|---|---|---|---|
| | Surface | | Ink | Printing | Insolubilization | | | depth | depth |
| | tackiness | Rinsing | transfer | durability | ratio (%) | | | (μm) | (μm) |
| | properties | properties | properties | (m) | Water | IPA | AcOBu | FC-LD | CO₂ laser |
| Ex. 1 | A | B | B | 1,700 | 97 | 90 | 87 | 450 | 350 |
| Ex. 2 | A | B | B | 2,000 | 98 | 93 | 90 | 430 | 335 |
| Ex. 3 | A | A | A | 2,500 | 100 | 97 | 97 | 400 | 315 |
| Ex. 4 | A | A | B | 2,400 | 100 | 96 | 96 | 395 | 310 |
| Ex. 5 | A | A | B | 2,100 | 99 | 95 | 94 | 400 | 320 |
| Ex. 6 | A | A | B | 1,900 | 98 | 93 | 92 | 405 | 325 |
| Ex. 7 | A | A | A | 2,200 | 98 | 95 | 95 | 410 | 320 |
| Ex. 8 | A | A | B | 2,100 | 97 | 94 | 94 | 405 | 315 |
| Ex. 9 | A | A | B | 1,900 | 96 | 94 | 92 | 405 | 310 |
| Ex. 10 | A | A | B | 1,700 | 95 | 92 | 91 | 390 | 300 |
| Ex. 11 | A | A | A | 2,200 | 100 | 95 | 95 | 380 | 280 |
| Ex. 12 | A | A | B | 2,000 | 99 | 94 | 93 | 400 | 310 |
| Ex. 13 | A | A | B | 1,700 | 95 | 92 | 91 | 410 | 330 |
| Ex. 14 | A | A | C | 1,600 | 99 | 94 | 93 | 370 | 280 |
| Ex. 15 | A | B | C | 1,300 | 90 | 87 | 85 | 375 | 285 |
| Ex. 16 | A | B | C | 1,400 | 85 | 88 | 90 | 380 | 290 |
| Ex. 18 | A | A | A | 2,450 | 100 | 97 | 95 | 400 | 325 |
| Ex. 19 | A | A | A | 2,400 | 100 | 96 | 95 | 405 | 320 |
| Ex. 20 | A | A | A | 2,600 | 100 | 99 | 99 | 410 | 325 |
| Ex. 21 | A | A | A | 2,450 | 100 | 96 | 94 | 430 | 335 |
| Ex. 22 | A | A | B | 2,000 | 99 | 93 | 93 | 405 | 320 |
| Ex. 23 | A | A | A | 2,400 | 98 | 95 | 95 | 400 | 325 |
| Ex. 24 | B | A | B | 2,000 | 97 | 91 | 90 | 390 | 315 |
| Ex. 25 | B | A | B | 1,800 | 95 | 92 | 89 | 380 | 300 |
| Ex. 26 | A | A | A | 2,300 | 99 | 95 | 96 | 420 | 335 |
| Ex. 27 | A | A | A | 2,400 | 98 | 96 | 95 | 420 | 340 |
| Ex. 28 | C | B | A | 2,200 | 100 | 96 | 95 | 0 | 290 |
| Ex. 29 | B | B | C | 1,300 | 100 | 97 | 97 | 380 | 305 |
| Comp. Ex. 1 | C | B | D | 300 | 70 | 65 | 55 | 350 | 260 |
| Comp. Ex. 2 | C | B | C | 700 | 60 | 60 | 55 | 380 | 290 |
| Comp. Ex. 3 | D | C | D | 300 | 80 | 75 | 65 | 350 | 260 |
| Comp. Ex. 4 | C | B | D | 200 | 60 | 55 | 55 | 340 | 260 |
| Comp. Ex. 5 | D | B | D | 300 | 65 | 58 | 57 | 320 | 230 |
| Comp. Ex. 6 | C | B | D | 400 | 66 | 59 | 59 | 350 | 250 |
| Comp. Ex. 7 | C | B | C | 700 | 90 | 88 | 79 | 390 | 290 |
| Comp. Ex. 8 | C | C | C | 700 | 88 | 86 | 79 | 280 | 180 |
| Comp. Ex. 9 | D | B | D | 200 | 81 | 74 | 64 | 280 | 190 |

What is claimed is:

1. A resin composition for laser engraving, comprising:
(Component A) an oligomer or polymer having a (meth)acryloyloxy group in the molecule;
(Component B) an ethylenically unsaturated compound;
(Component C) a compound having in the molecule at least one type selected from the group consisting of a mercapto group, a primary amino group, and a secondary amino group and at least one type of hydrolyzable silyl group and/or silanol group; and
(Component D) a thermopolymerization initiator.

2. The resin composition for laser engraving according to claim 1, wherein Component A has a urethane bond in the molecule.

3. The resin composition for laser engraving according to claim 1, wherein Component A is a straight-chain oligomer or polymer and has a (meth)acryloyloxy group at both termini.

4. The resin composition for laser engraving according to claim 2, wherein Component A is a straight-chain oligomer or polymer and has a (meth)acryloyloxy group at both termini.

5. The resin composition for laser engraving according to claim 1, wherein it further comprises (Component E) a photothermal conversion agent.

6. The resin composition for laser engraving according to claim 4, wherein it further comprises (Component E) a photothermal conversion agent.

7. The resin composition for laser engraving according to claim 1, wherein it further comprises (Component F) an alcohol exchange reaction catalyst.

8. The resin composition for laser engraving according to claim 4, wherein it further comprises (Component F) an alcohol exchange reaction catalyst.

9. The resin composition for laser engraving according to claim 6, wherein it further comprises (Component F) an alcohol exchange reaction catalyst.

10. The resin composition for laser engraving according to claim 1, wherein it further comprises (Component G) a silane coupling agent.

11. The resin composition for laser engraving according to claim 4, wherein it further comprises (Component G) a silane coupling agent.

12. The resin composition for laser engraving according to claim 9, wherein it further comprises (Component G) a silane coupling agent.

13. A flexographic printing plate precursor for laser engraving, comprising above a support a relief-forming layer comprising the resin composition for laser engraving according to claim 1.

14. A flexographic printing plate precursor for laser engraving, comprising above a support a crosslinked relief-forming layer formed by crosslinking by means of heat a relief-forming layer comprising the resin composition for laser engraving according to claim 1.

15. A flexographic printing plate precursor for laser engraving, comprising above a support a crosslinked relief-forming layer formed by crosslinking by means of heat a relief-forming layer comprising the resin composition for laser engraving according to claim 12.

16. A process for producing a flexographic printing plate precursor for laser engraving, the process comprising:
a layer formation step of forming a relief-forming layer comprising the resin composition for laser engraving according to claim 1; and
a crosslinking step of crosslinking the relief-forming layer by means of heat to thus obtain a flexographic printing plate precursor comprising a crosslinked relief-forming layer.

17. A process for producing a flexographic printing plate precursor for laser engraving, the process comprising:
a layer formation step of forming a relief-forming layer comprising the resin composition for laser engraving according to claim 12; and
a crosslinking step of crosslinking the relief-forming layer by means of heat to thus obtain a flexographic printing plate precursor comprising a crosslinked relief-forming layer.

18. A process for making a flexographic printing plate, comprising in this order:
a step of preparing a flexographic printing plate precursor for laser engraving comprising a crosslinked relief-forming layer formed by crosslinking by means of heat a relief-forming layer comprising the resin composition for laser engraving according to claim 1; and
an engraving step of laser-engraving the crosslinked relief-forming layer so as to form a relief layer.

19. A flexographic printing plate produced by the process according to claim 18.

20. The flexographic printing plate according to claim 19, wherein the relief layer has a thickness of at least 0.05 mm but no greater than 10 mm.
